(19) United States
(12) Patent Application Publication
(10) Pub. No.: US 2026/0252710 A1
(43) Pub. Date: Aug. 27, 2026

(54) DETERMINATION DEVICE, DETERMINATION METHOD, AND RECORDING MEDIUM

(71) Applicant: NEC Corporation, Tokyo (JP)

(72) Inventors: Shunichi KINOSHITA, Tokyo (JP); Hirofumi UEDA, Tokyo (JP); Norio YAMAGAKI, Tokyo (JP); Mamoru SAITA, Tokyo (JP)

(73) Assignee: NEC Corporation, Tokyo (JP)

(21) Appl. No.: 19/422,731

(22) Filed: Dec. 17, 2025

(30) Foreign Application Priority Data
Feb. 27, 2025 (JP) 2025-029660

(51) Int. Cl. G06F 21/57

(52) U.S. Cl. CPC G06F 21/577

(57) ABSTRACT

Provided is a determination device including an acquisition unit that acquires a vulnerability identifier for uniquely identifying a vulnerability, a search unit that searches for vulnerability information identified by the vulnerability identifier by referring to a database in which vulnerability information for each vulnerability identifier is registered, a generation unit that generates an instruction to determine necessity of responding to a vulnerability identified by the vulnerability identifier by using the vulnerability information identified by the vulnerability identifier and a norm regarding information security, and an output unit that outputs determination data including a determination result output from a model in response to the instruction.

This application is based upon and claims the benefit of priority from Japanese patent application No. 2025-029660, filed on February 27, 2025, the disclosure of which is incorporated herein in its entirety by reference.

### TECHNICAL FIELD

The present invention relates to a determination device, a determination method, and a program.

### BACKGROUND ART

As the importance of information security increases, vulnerability responding in accordance with norms such as various guidelines, standards, laws, internal regulations, and the like is required. These norms have an important role in enhancing security preparations of an organization and protecting the organization from potential threats. A person in charge of security in the organization needs to analyze these guidelines and the like in detail, evaluate the relevance to a vulnerability existing in the organization, and determine the necessity of a response. However, the contents of the guidelines and the like are often complicated and diverse, and it takes considerable time and labor to understand and apply the guidelines and the like.

PTL 1 (JP 2024-042396 A) discloses an information processing device that supports investigation of a vulnerability of target software. The device in PTL 1 includes a vulnerability database, a matching unit, a cause element identifying unit, a type determination unit, and an output unit. The vulnerability database stores one or more pieces of vulnerability information including a vulnerability identifier for uniquely identifying a vulnerability, a software identifier for uniquely identifying software including the vulnerability, and a vulnerability description indicating contents of the vulnerability. The matching unit identifies vulnerability information matching a software identifier of target software provided in a target device in the vulnerability database. The cause element identifying unit identifies a cause element that causes a vulnerability from the vulnerability description in the vulnerability information identified by the matching unit. The type determination unit determines the type of the cause element from the name of the identified cause element. The output unit determines an investigation method regarding the vulnerability of the target software based on the software identifier of the target software and the type of the cause element, and outputs information indicating the investigation method.

The technique in PTL 1 focuses on identification of a vulnerability and determination of an investigation method. However, the technique in PTL 1 does not evaluate the relevance to norms such as various guidelines, standards, laws, internal regulations, and the like. Therefore, in the technique in PTL 1, in vulnerability responding, it is not possible for a worker to make a decision in accordance with a norm regarding information security.

An object of the present disclosure is to provide a determination device, a determination method, and a program capable of presenting a determination result that supports decision-making of a worker in vulnerability responding, in accordance with a norm regarding information security.

### SUMMARY

According to an aspect of the present disclosure, a determination device includes an acquisition unit that acquires a vulnerability identifier for uniquely identifying a vulnerability, a search unit that refers to a database in which vulnerability information for each vulnerability identifier is registered and searches for vulnerability information identified by the vulnerability identifier, a generation unit that generates an instruction to determine necessity of responding to a vulnerability identified by the vulnerability identifier by using the vulnerability information identified by the vulnerability identifier and a norm regarding information security, and an output unit that outputs determination data including a determination result output from a model in response to the instruction.

According to another aspect of the present disclosure, a determination method includes, by a computer, acquiring a vulnerability identifier for uniquely identifying a vulnerability, referring to a database in which vulnerability information for each vulnerability identifier is registered and searching for vulnerability information associated with the vulnerability identifier, generating an instruction to determine necessity of responding to a vulnerability identified by the vulnerability identifier by using the vulnerability information identified by the vulnerability identifier and a norm regarding information security, and outputting determination data including a determination result output from a model in response to the instruction.

According to still another aspect of the present disclosure, a program causes a computer to execute a process including acquiring a vulnerability identifier for uniquely identifying a vulnerability, referring to a database in which vulnerability information for each vulnerability identifier is registered and searching for vulnerability information associated with the vulnerability identifier, generating an instruction to determine necessity of responding to a vulnerability identified by the vulnerability identifier by using the vulnerability information identified by the vulnerability identifier and a norm regarding information security, and outputting determination data including a determination result output from a model in response to the instruction.

According to the present disclosure, it is possible to provide a determination device, a determination method, and a program capable of presenting a determination result that supports decision-making of a worker in vulnerability responding, in accordance with a norm regarding information security.

### BRIEF DESCRIPTION OF THE DRAWINGS

FIG. 1 is a block diagram illustrating an example of a configuration relating to a determination device in the present disclosure;

FIG. 2 is a block diagram illustrating an example of a configuration of the determination device in the present disclosure;

FIG. 3 is a table showing an example of vulnerability information stored in a database referred to by the determination device in the present example embodiment;

FIG. 4 is information showing an example of norm information referred to by the determination device in the present example embodiment;

FIG. 5 is a conceptual diagram illustrating an example of a prompt generated by the determination device in the present disclosure;

FIG. 6 is a conceptual diagram illustrating an example of a prompt generated by the determination device in the present disclosure;

FIG. 7 is a conceptual diagram illustrating a display example of attack information output from the determination device in the present disclosure;

FIG. 8 is a flowchart illustrating an example of an operation of the determination device in the present disclosure;

FIG. 9 is a flowchart illustrating an example of a determination process by the determination device in the present disclosure;

FIG. 10 is a conceptual diagram illustrating an example of norm information referred to by a determination device in the present disclosure;

FIG. 11 is a conceptual diagram illustrating an example of a prompt generated by the determination device in the present disclosure;

FIG. 12 is a conceptual diagram illustrating an example of a prompt generated by the determination device in the present disclosure;

FIG. 13 is a conceptual diagram illustrating an example in which a user interface that receives an input of an answer to a question output from the determination device in the present disclosure is displayed on a screen of a terminal device;

FIG. 14 is a conceptual diagram illustrating another example of the prompt generated by the determination device in the present disclosure;

FIG. 15 is a conceptual diagram illustrating an example of norm information referred to by a determination device in the present disclosure;

FIG. 16 is a conceptual diagram illustrating an example of a prompt generated by the determination device in the present disclosure;

FIG. 17 is a conceptual diagram illustrating an example of a prompt generated by the determination device in the present disclosure;

FIG. 18 is a conceptual diagram illustrating an example of norm information referred to by a determination device in the present disclosure;

FIG. 19 is a conceptual diagram illustrating an example of a prompt generated by the determination device in the present disclosure;

FIG. 20 is a conceptual diagram illustrating an example of a prompt generated by the determination device in the present disclosure;

FIG. 21 is a block diagram illustrating an example of a configuration of a determination device in the present disclosure;

FIG. 22 is a conceptual diagram illustrating an example of a vulnerability diagnosis report acquired by the determination device in the present disclosure;

FIG. 23 is a conceptual diagram illustrating an example in which the determination device in the present disclosure extracts a vulnerability identifier from the vulnerability diagnosis report;

FIG. 24 is a flowchart illustrating an example of an operation of the determination device in the present disclosure;

FIG. 25 is a flowchart illustrating an example of a determination process by the determination device in the present disclosure;

FIG. 26 is a block diagram illustrating an example of a configuration of a determination device in the present disclosure;

FIG. 27 is a flowchart illustrating an example of an operation of the determination device in the present disclosure; and

FIG. 28 is a block diagram illustrating an example of a hardware configuration that executes processing in the present disclosure.

### EXAMPLE EMBODIMENT

Hereinafter, modes for carrying out the present disclosure will be described with reference to the drawings. In the present disclosure, the drawings used in description of each example embodiment are associated with one or more example embodiments. Elements included in each drawing may apply to one or more example embodiments. The example embodiments described below have technically preferable limitations for carrying out the present disclosure, but the scope of the disclosure is not limited to the following. In all the drawings used in the following description of the example embodiments, the same reference signs are given to similar parts unless otherwise specified. In the following example embodiments, repeated description of similar configurations and operations may sometimes be omitted. The directions of the arrows in the drawings indicate examples of flows of signals, data, and the like and do not limit the flows of signals, data, and the like.

### First Example Embodiment

First, a determination device according to a first example embodiment will be described with reference to the drawings. The determination device in the present example embodiment presents a determination result regarding a vulnerability conforming to a norm regarding information security to a worker who is performing vulnerability management. The norm regarding information security is a matter to be implemented or a matter to be observed regarding information security. Examples of the norm regarding information security include guidelines, standards, laws, and internal regulations. The contents of these norms are complex. Therefore, considerable man-hours are required to understand these norms. The determination device in the present example embodiment reduces man-hours of a worker by supporting decision-making of the worker in vulnerability responding in accordance with the norm regarding information security.

Hereinafter, a criterion for a vulnerability to which responding is to be performed, which is described by norms such as guidelines, standards, laws, internal regulations, and the like is also referred to as a vulnerability evaluation index. A base score, a temporal score, and an environmental score of a common vulnerability scoring system (CVSS) are examples of the vulnerability evaluation index. An exploit prediction scoring system (EPSS) and a vulnerability priority rating (VPR) are examples of the vulnerability evaluation index. A flag indicating the presence or absence of public proof of concept (PoC) and a flag indicating the presence or absence of an occurrence of an attack are examples of the vulnerability evaluation index. These vulnerability evaluation indexes may be defined alone or in combination.

### Configuration

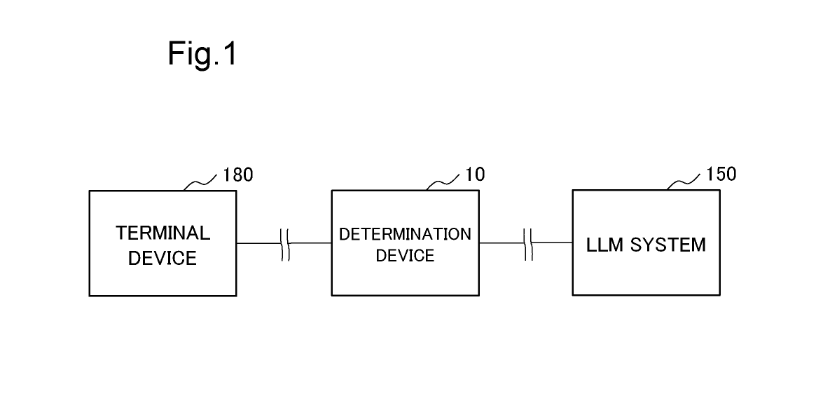

FIG. 1 is a block diagram illustrating an example of a configuration relating to the determination device in the present disclosure. A determination device 10 is connected to a terminal device 180 and an LLM system 150 via a network such as the Internet or an intranet. The determination device 10 is a device that executes processing related to vulnerability management. For example, the determination device 10 has functions such as analysis of a result of vulnerability management, evaluation of a vulnerability, and proposal of security countermeasures. Details of the determination device 10 will be described later.

The terminal device 180 is an information processing device (computer) used for vulnerability management in a management target system. The terminal device 180 provides an interface for a worker to access a result of vulnerability diagnosis, a penetration test, or an asset inventory. Application software for performing vulnerability management is installed on the terminal device 180. The terminal device 180 identifies a vulnerability in the management target system by executing processing set by the worker. For example, the terminal device 180 identifies a vulnerability by performing vulnerability scan or a penetration test on the management target system. The function of the application software for performing the vulnerability scan or the penetration test may be built in a server or a cloud accessible from the terminal device 180. For example, the terminal device 180 identifies a vulnerability in the management target system by referring to an asset inventory in which software and/or a version of software used in the management target system are described. The asset inventory in which the software and/or the version of the software used in the management target system are described may be built in a server or a cloud accessible from the terminal device 180. The terminal device 180 may be achieved by a general-purpose computer. The terminal device 180 may be achieved by a dedicated computer for identifying a vulnerability.

The terminal device 180 outputs information (vulnerability identifier) indicating a vulnerability identified in the management target system to the determination device 10. The vulnerability identifier is an identifier for uniquely identifying a vulnerability of a system. For example, the vulnerability identifier is a common vulnerabilities and exposures (CVE) number or an identifier (ID) of a detection item of a vulnerability scanner. As long as a vulnerability can be uniquely identified, the vulnerability identifier may be other than the CVE number and the ID of the detection item of the vulnerability scanner. The vulnerability in a broad sense includes setting incompletion. For example, as an example of the setting incompletion, there is an example in which an anonymous file transfer protocol (FTP) is set to be valid. Information (vulnerability information) regarding a vulnerability for each vulnerability identifier is stored in advance in a database (which will be described later) of the determination device 10.

For example, the terminal device 180 may be configured to output an attack work history of the penetration test performed by the worker to the determination device 10. The attack work history performed in the penetration test includes at least one attack technique performed for each attack step and attack contents related to a result of the performed attack technique. The attack technique is selected by the worker. For example, the attack technique is denoted by any of a tactic, a technique, a procedure, and a tool name. For example, the attack technique may be defined by a combination of a tactic, a technique, a procedure, and a tool name. For example, the attack contents are a command used for the attack, an option of the used command, and an execution result of the used command.

Examples of the attack technique include a network attack, a web application attack, an authentication and access control attack, social engineering, a system-level attack, and a highly targeted attack. For example, the network attack includes port scanning, a man-in-the-middle attack, a denial-of-service attack, and domain name system (DNS) poisoning. For example, the network attack includes address resolution protocol (ARP) spoofing and a wireless network attack. For example, the web application attack includes structured query language (SQL) injection, cross-site scripting, session hijacking, and directory traversal. For example, the authentication and access control attack includes password cracking and privilege escalation. For example, the social engineering includes phishing. For example, the system-level attack includes a buffer overflow attack, a memory corruption attack, and a reverse shell. For example, the highly targeted attack includes exploit of a zero-day vulnerability, a ransomware attack simulation, and a supply chain attack simulation.

The LLM system 150 is a system that executes processing using a large-scale language model (not illustrated). The large-scale language model (also referred to as a model) is a deep learning model trained using a large-scale language data set. The LLM system 150 outputs text information according to the contents of text information configured in a natural language by using the large-scale language model. The LLM system 150 provides a result of vulnerability management in easy-to-understand text information by using the large-scale language model. That is, the LLM system 150 converts complex security information into a format that is easy for a human to understand. For example, the LLM system 150 outputs an answer in response to an input of a question. The LLM system 150 may be a model capable of inputting and outputting images and sounds. For example, the LLM system 150 is a system available via an application programming interface (API). The LLM system 150 may be configured to use a dedicated model built for implementing vulnerability management. As long as an access from the determination device 10 is possible, no limitation is imposed on the type of the large-scale language model used by the LLM system 150 and a place where the LLM system 150 is disposed.

### Determination Device

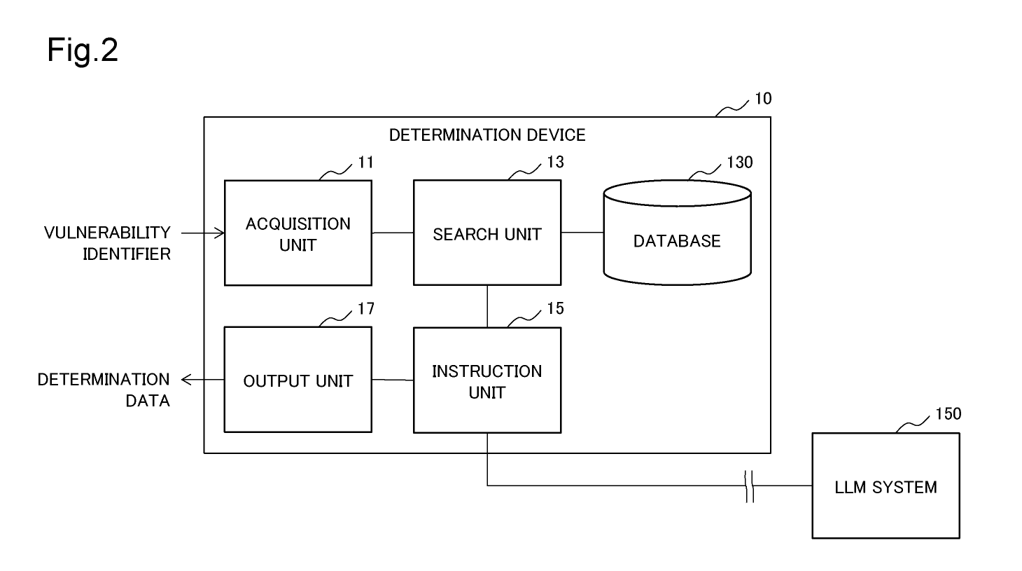

Next, an example of a configuration of the determination device 10 will be described with reference to the drawings. FIG. 2 is a block diagram illustrating the example of the configuration of the determination device in the present disclosure. The determination device 10 includes an acquisition unit 11, a search unit 13, an instruction unit 15, and an output unit 17. The determination device 10 further includes a database 130. The database 130 may be configured outside the determination device 10 as long as the determination device 10 can refer to the database 130. The instruction unit 15 is connected to the LLM system 150.

The acquisition unit 11 is connected to the terminal device 180 used by the worker. The acquisition unit 11 acquires a vulnerability identifier indicating a vulnerability identified in the vulnerability management from the terminal device 180 used by the worker. For example, the acquisition unit 11 acquires a vulnerability identifier indicating a vulnerability detected by the vulnerability scanner. For example, the vulnerability identifier includes a CVE number, a plug-in ID of the vulnerability scanner, and the like.

The database 130 is configured as a storage device connectable by the determination device 10. The database 130 stores vulnerability information and norm information. The database 130 may be an external database in which vulnerability information for each vulnerability identifier is disclosed. In this case, the database 130 does not need to be included in the determination device 10. For example, the database 130 is configured as a dedicated database specialized for vulnerability diagnosis of a management target system. For example, it is possible to make more accurate determination by using a dedicated database in which paid information purchased from another vendor is registered. In such a case, the database 130 may be configured inside the device or may be configured outside the device. For example, the determination device 10 may be configured to refer to an external database and a dedicated database. In that case, the determination device 10 can more accurately determine a response to a vulnerability by referring to public data stored in the external database and private data stored in the dedicated database. For example, a relational database management system that enables high-speed query processing and efficient management of large-volume data is used for the database 130. When attack record information is normalized and retained by using a plurality of tables, it is possible to maintain consistency of data and to perform flexible search and analysis.

The vulnerability information is information associated with the vulnerability identifier. For example, the vulnerability information is information in which information associated with a vulnerability identifier is collected in a table format. For example, the vulnerability information is a base score, a temporal score, or an environmental score of a common vulnerability scoring system (CVSS). For example, the vulnerability information is an exploit prediction scoring system (EPSS) or a vulnerability priority rating (VPR). For example, the vulnerability information is a flag indicating the presence or absence of public proof of concept (PoC) and the presence or absence of an occurrence of an attack. For example, the vulnerability information is a category of a vulnerability.

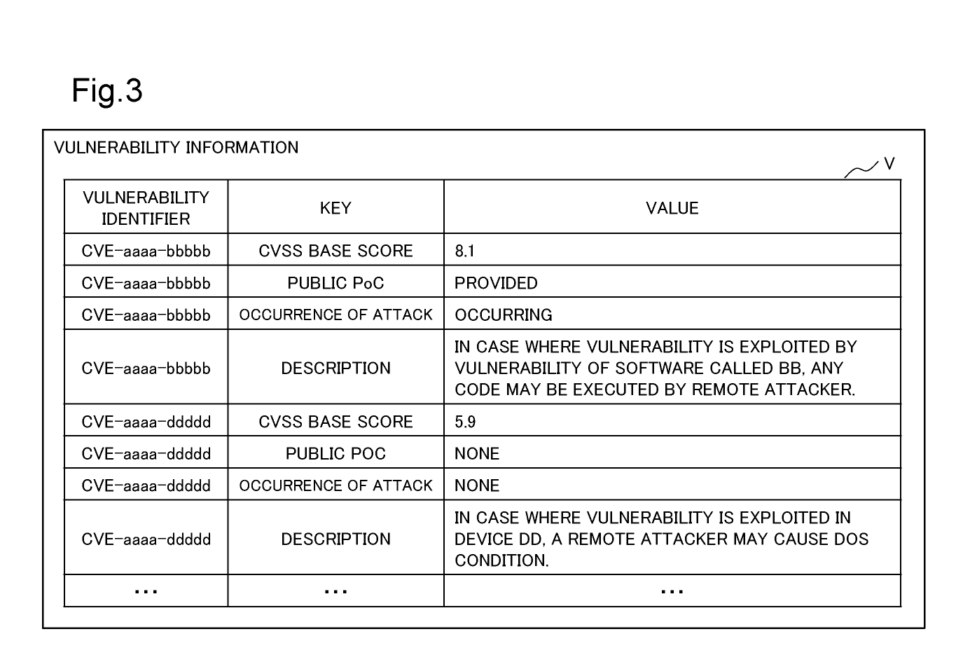

FIG. 3 is a table showing an example of vulnerability information stored in a database referred to by the determination device in the present example embodiment. In a vulnerability information table V, a plurality of pieces of data in which a key indicating vulnerability information and a value corresponding to the key are associated one-to-one are stored for each vulnerability identifier. As in the example of FIG. 3, a unique value is associated with each key. For example, the value of “CVSS base score” of a vulnerability identifier CVE-aaaa-bbbbb is “8.1”. For example, the value of “public PoC” of the vulnerability identifier CVE-aaaa-bbbbb is a flag “provided”. For example, the value of “attack occurrence” of the vulnerability identifier CVE-aaaa-bbbbb is a flag “occurring”. For example, the value of “description” of a vulnerability identifier CVE-aaaa-ddddd is information indicating “in a case where a vulnerability in a device DD is exploited, a remote attacker may cause a DOS condition”.

The norm information includes information regarding norms such as guidelines, standards, laws, internal regulations, and the like regarding information security. For example, the norm information is a document regarding norms such as guidelines, standards, laws, internal regulations, and the like regarding information security. For example, the norm information may be information extracted from a document regarding norms such as guidelines, standards, laws, internal regulations, and the like regarding information security. The vulnerability information and the norm information may be stored in databases built in different storage devices.

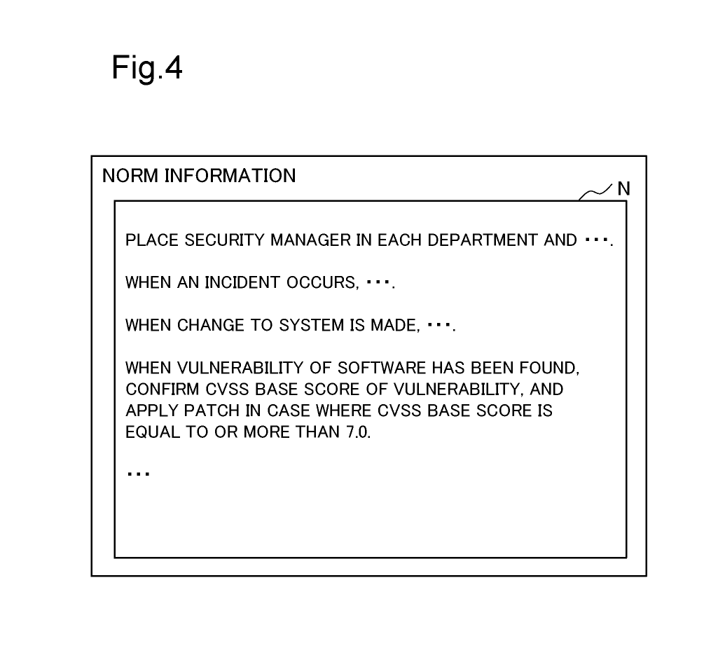

FIG. 4 is information showing an example of the norm information referred to by the determination device in the present example embodiment. For example, norm information N is a document regarding norms such as guidelines, standards, laws, internal regulations, and the like regarding information security. For example, the norm information N includes norms regarding vulnerabilities of cyber security. For example, the norm information N is a norm regarding an operation of cyber security.

The search unit 13 searches the database 130 for vulnerability information associated with a vulnerability identifier. For example, the search unit 13 acquires data including a key and a value as the vulnerability information. The search unit 13 searches the database 130 for the norm information referred to in the vulnerability management. For example, the search unit 13 may be configured to search for the vulnerability information and the norm information via the Internet.

The instruction unit 15 acquires the vulnerability information and the norm information searched by the search unit 13. The instruction unit 15 generates a prompt (also referred to as an instruction) by using the acquired vulnerability information and norm information. A functional configuration of the instruction unit 15 for generating a prompt (instruction) is also referred to as a generation unit. The instruction unit 15 inputs the generated prompt into the LLM system 150. In the present example embodiment, the instruction unit 15 generates a first prompt and a second prompt.

The instruction unit 15 generates a first prompt for inputting the contents of the norm information to the LLM system 150. The first prompt includes the contents of the norm information. The instruction unit 15 generates the first prompt by using a template set in advance. The template for generating the first prompt includes an instruction sentence to set the contents of the norm information as a precondition.

The instruction unit 15 inputs the generated first prompt into the LLM system 150.

The instruction unit 15 acquires text information output from the LLM system 150 in response to an input of the first prompt. The text information output from the LLM system 150 in response to the input of the first prompt is relevant to an answer to the first prompt. The answer to the first prompt triggers the determination device 10 to input a second prompt into the LLM system 150.

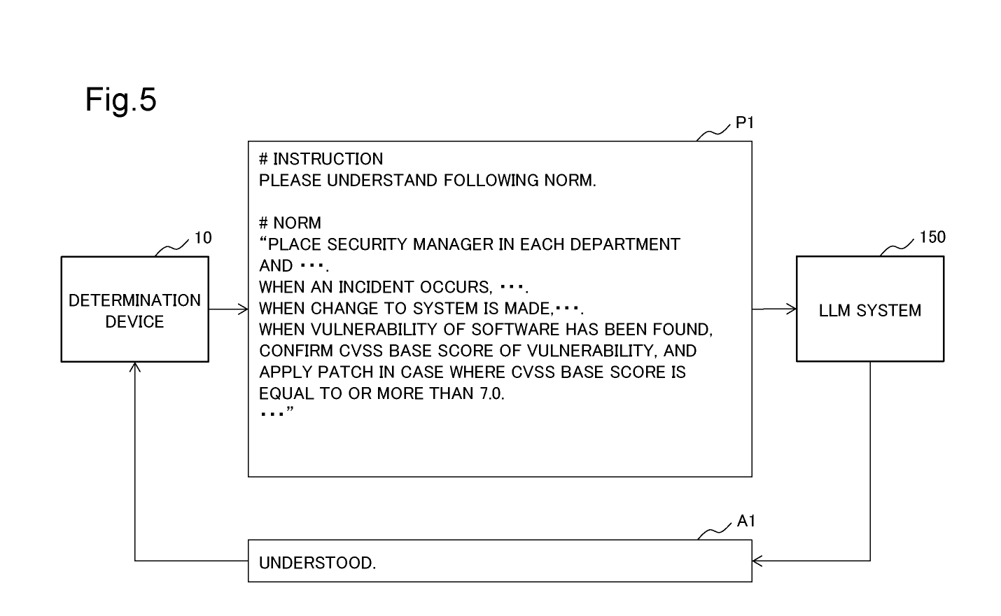

FIG. 5 is a conceptual diagram illustrating an example of the prompt generated by the determination device in the present disclosure. FIG. 5 illustrates an example of a first prompt P1 generated by the determination device 10. The first prompt P1 includes information indicating an instruction sentence and a norm. The instruction sentence includes text information that “please understand the following norm”. The norm includes a sentence related to the norm illustrated in FIG. 4. FIG. 5 illustrates an answer A1 output from the LLM system 150 in response to the input of the first prompt P1. The answer A1 includes text information indicating that the contents of the first prompt P1 are set as a precondition for the LLM system 150, that is, “understood”.

The instruction unit 15 generates a second prompt for instructing the LLM system 150 to determine necessity of responding to a vulnerability indicated by the vulnerability identifier. The second prompt includes an instruction to determine the necessity of responding to the vulnerability indicated by the vulnerability identifier. The instruction unit 15 generates the second prompt by using a template set in advance. The instruction unit 15 inputs the generated second prompt into the LLM system 150. The instruction unit 15 may be configured to generate a prompt in which the contents of the first prompt and the contents of the second prompt are unified. In that case, the prompt includes an instruction to set the contents of the norm information as a precondition, and an instruction to determine the necessity of responding to the vulnerability indicated by the vulnerability identifier.

The instruction unit 15 acquires text information (determination result) output from the LLM system 150 in response to an input of the second prompt. The text information output from the LLM system 150 in response to the input of the second prompt is relevant to an answer to the second prompt. The answer to the second prompt includes a determination result of the necessity of responding to the vulnerability indicated by the vulnerability identifier.

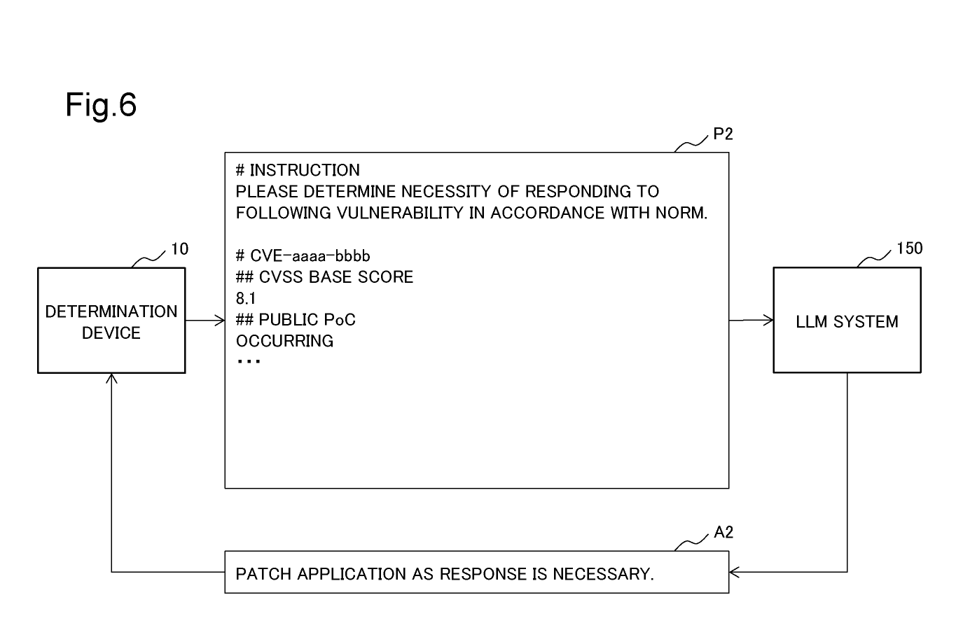

FIG. 6 is a conceptual diagram illustrating an example of a prompt generated by the determination device in the present disclosure. FIG. 6 illustrates an example of a second prompt P2 generated by the determination device 10. The second prompt P2 includes an instruction sentence and vulnerability information associated with the vulnerability identifier. The instruction sentence includes text information that “please determine the necessity of responding to the following vulnerability in accordance with the norm”. The vulnerability information includes a plurality of pieces of data in which a key and a value relevant to the vulnerability identifier are associated one-to-one. FIG. 6 illustrates an answer A2 output from the LLM system 150 in response to the input of the second prompt P2. The answer A2 includes text information that “patch application as a response is necessary”. The answer A2 includes a determination result of the necessity of responding to the vulnerability indicated by the vulnerability identifier based on information input by the first prompt P1.

In the above description, the instruction unit 15 inputs information to the LLM system 150 by using the first prompt and the second prompt and acquires the determination result of the necessity of responding to the vulnerability, and the present example embodiment is not limited to this. For example, the instruction unit 15 may input information to the LLM system 150 by using retrieval-augmented generation (RAG) or fine tuning instead of the first prompt in the above description. For example, the instruction unit 15 may generate a single prompt including both information included in the first prompt and information included in the second prompt. In that case, the instruction unit 15 inputs this single prompt to the LLM system 150, and acquires text information regarding a determination result of necessity of responding to the vulnerability, which has been output from the LLM system 150.

The output unit 17 is connected to the terminal device 180 used by the worker. The output unit 17 acquires, from the instruction unit 15, a determination result of the necessity of responding to the vulnerability indicated by the vulnerability identifier. The output unit 17 outputs determination data including the acquired determination result to the terminal device 180. The determination result included in the determination data output to the terminal device 180 is displayed on a screen of the terminal device 180.

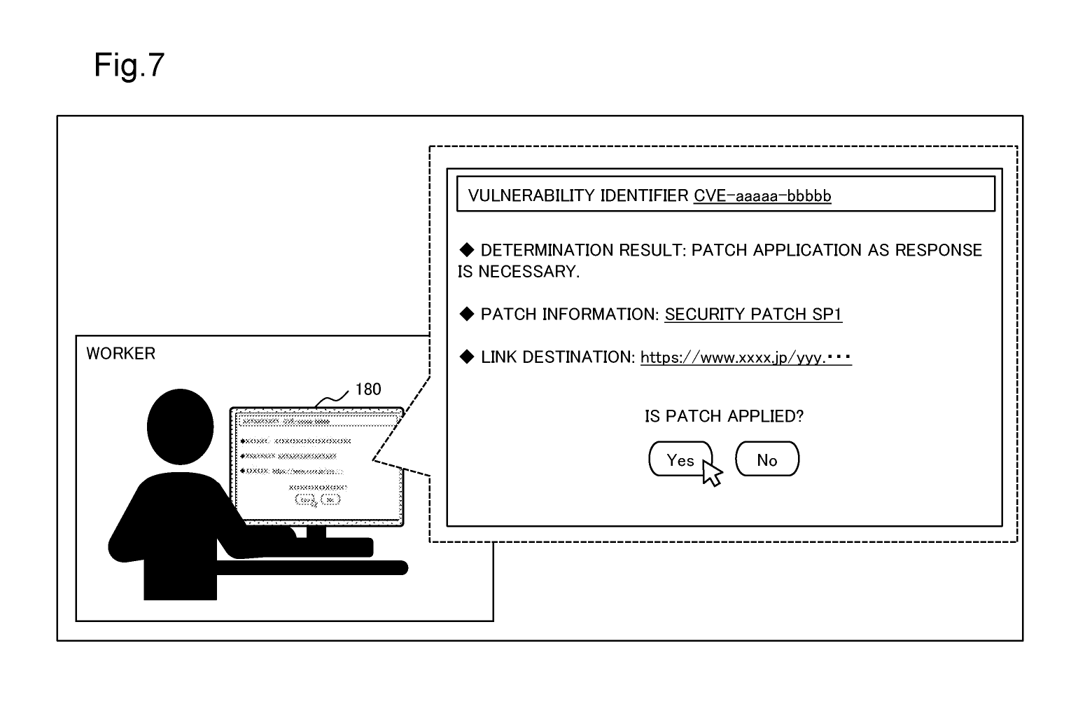

FIG. 7 is a conceptual diagram illustrating a display example of attack information output from the determination device in the present disclosure. On an upper part of the screen of the terminal device 180, a vulnerability identifier indicating a vulnerability identified in vulnerability management is displayed. Text information indicating a determination result “patch application as a response is necessary.” is displayed on the screen of the terminal device 180. Patch information “security patch SP1” is displayed on the screen of the terminal device 180. A link destination related to the patch information is displayed on the screen of the terminal device 180. A user interface (UI) that receives application of a patch is further displayed on the screen of the terminal device 180. In the example of FIG. 7, a button for applying a patch is displayed. A cursor for selecting the button for applying a patch is superimposed on that button. The worker can examine application of a patch by viewing information displayed on the screen of the terminal device 180.

### Operation

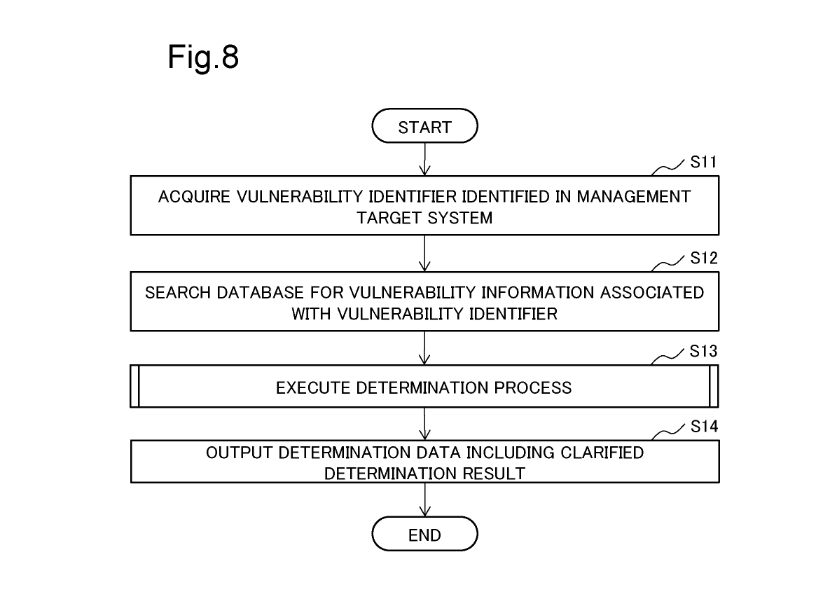

Next, an example of an operation of the determination device in the present disclosure will be described with reference to the drawings. FIG. 8 is a flowchart illustrating the example of the operation of the determination device in the present disclosure. In the description of processing as per the flowchart in FIG. 8, a component of the determination device 10 is assumed as an operating subject. The operating subject of the processing as per the flowchart in FIG. 8 may be the determination device 10. For example, the processing as per the flowchart in FIG. 8 is achieved by a processor executing a program stored in a memory mounted in a computer (not illustrated) in which the determination device 10 is implemented.

In FIG. 8, first, the acquisition unit 11 acquires a vulnerability identifier identified in a management target system (Step S11).

Then, the search unit 13 searches the database 130 for vulnerability information associated with the vulnerability identifier (Step S12). The search unit 13 may be configured to search for the vulnerability information via the Internet.

Then, the instruction unit 15 executes a determination process (Step S13). The details of the determination process in Step S13 will be described later.

Then, the output unit 17 outputs determination data including the clarified determination result (Step S14). A determination result output from the determination device 10 is displayed on the screen of the terminal device 180 used to perform vulnerability management.

### Determination Process

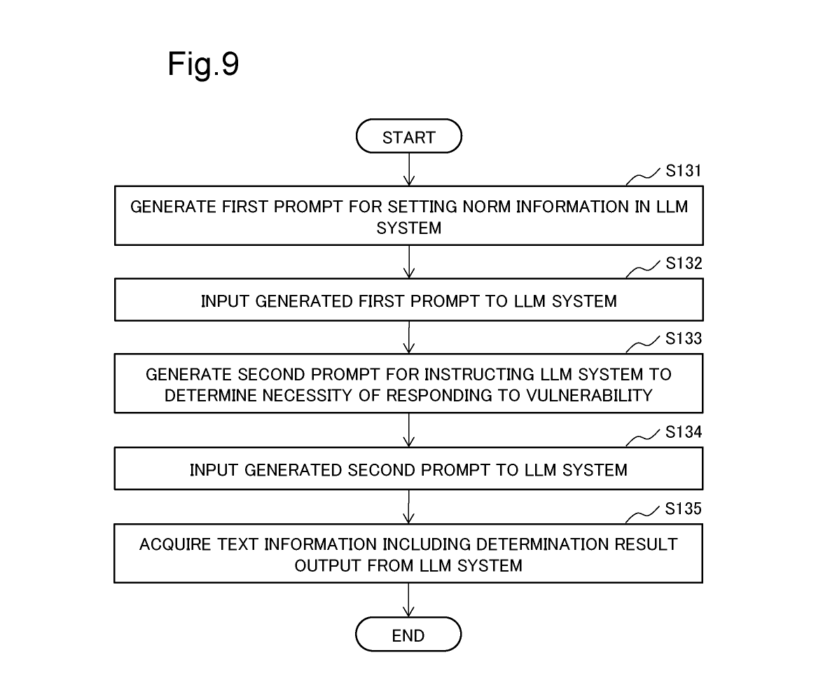

Next, an example of the determination process (Step S13 in FIG. 8) by the determination device in the present disclosure will be described with reference to the drawings. FIG. 9 is a flowchart illustrating an example of the determination process by the determination device in the present disclosure. In the description of the process as per the flowchart in FIG. 9, a component (instruction unit 15) of the determination device 10 is assumed as an operating subject. The operating subject of the process as per the flowchart in FIG. 9 may be the determination device 10.

In FIG. 9, first, the instruction unit 15 generates a first prompt for setting norm information in the LLM system 150 (Step S131).

Then, the instruction unit 15 inputs the generated first prompt into the LLM system 150 (Step S132). The instruction unit 15 acquires text information output from the LLM system 150 in response to an input of the first prompt.

Then, the instruction unit 15 generates a second prompt for instructing the LLM system 150 to determine necessity of responding to a vulnerability (Step S133).

Then, the instruction unit 15 inputs the generated second prompt into the LLM system 150 (Step S134).

Then, the instruction unit 15 acquires text information including the determination result output from the LLM system 150 (Step S135). After Step S135, the process proceeds to Step S14 in the flowchart in FIG. 8.

### Modifications

Next, a modification of the present example embodiment will be described with reference to the drawings. Here, three modifications will be described. The following modifications are examples of processing by the determination device in the present example embodiment, and do not limit processing by the determination device in the present example embodiment.

### First Modification

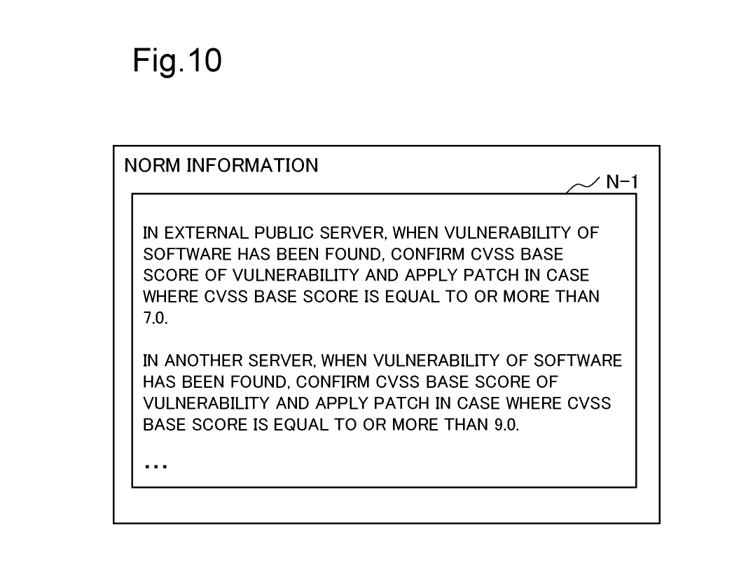

FIGS. 10 to 14 are conceptual diagrams relating to a first modification. The present modification is an example in which the LLM system 150 presents, to a worker, a user interface for requesting an input of auxiliary information for determining necessity of responding to a vulnerability. The auxiliary information is missing information or information for more appropriate determination in determination of necessity of responding to a vulnerability. The auxiliary information is requested by the LLM system 150 from the determination device 10 in order to determine the necessity of responding to the vulnerability.

FIG. 10 is a conceptual diagram illustrating an example of norm information referred to by the determination device in the present disclosure. In norm information N-1, it is designated to determine whether to apply a patch according to the value of a vulnerability evaluation index in a case where the vulnerability of the software has been found in a server. For example, in an external public server, when the vulnerability of the software has been found, it is designated to confirm a CVSS base score of the vulnerability and to apply a patch in a case where the CVSS base score is equal to or more than 7.0. For example, in another server, when the vulnerability of the software has been found, it is designated to confirm a CVSS base score of the vulnerability and to apply a patch in a case where the CVSS base score is equal to or more than 9.0.

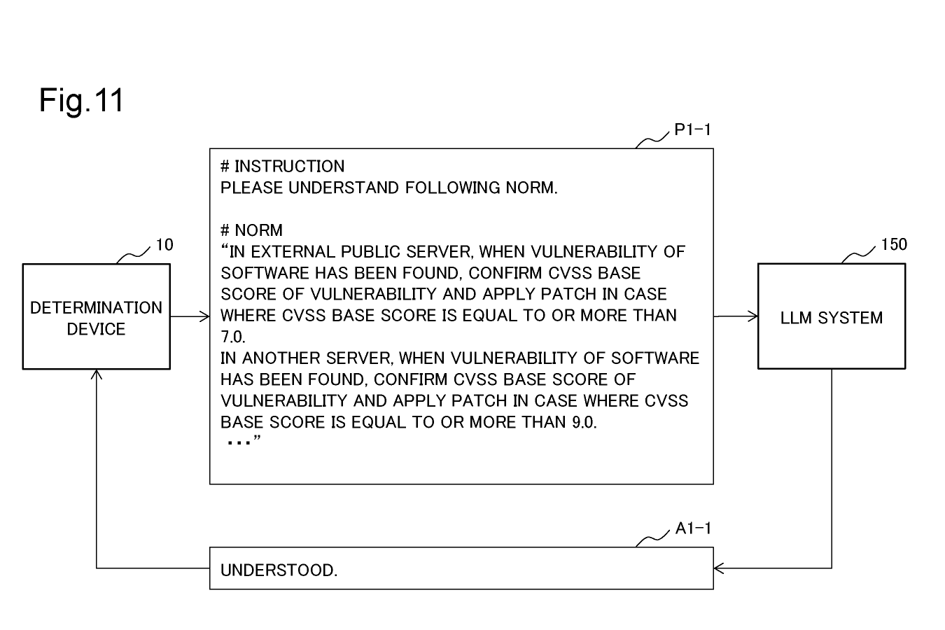

FIG. 11 is a conceptual diagram illustrating an example of a prompt generated by the determination device in the present disclosure. FIG. 11 illustrates an example of a first prompt P1-1 generated by a determination device 10. The first prompt P1-1 includes information indicating an instruction sentence and a norm. The instruction sentence includes text information that “please understand the following norm”. The norm includes a sentence related to the norm illustrated in FIG. 10. FIG. 11 illustrates an answer A1-1 output from the LLM system 150 in response to the input of the first prompt P1-1. The answer A1-1 includes text information indicating that the contents of the first prompt P1-1 are set as a precondition for the LLM system 150, that is, “understood”.

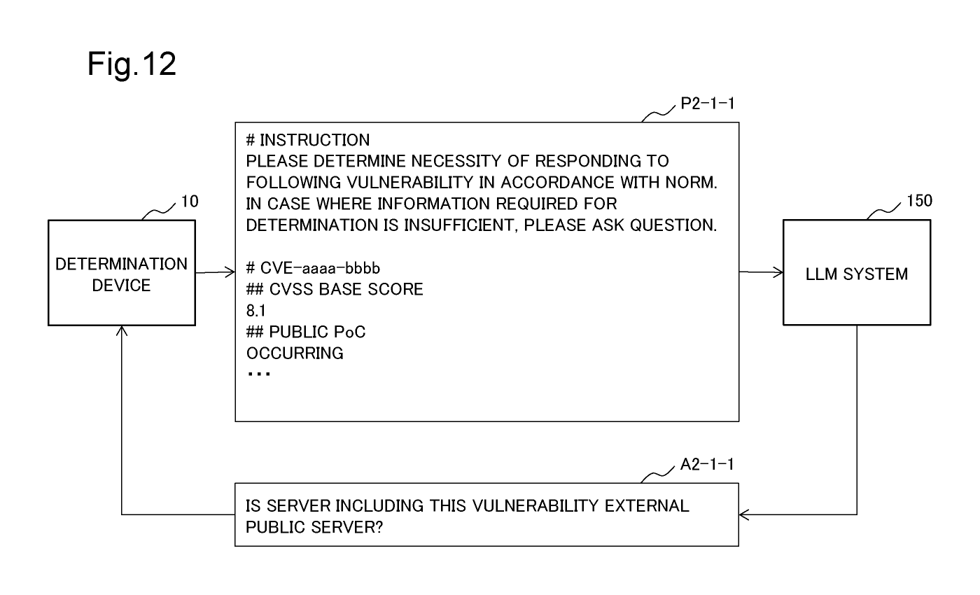

FIG. 12 is a conceptual diagram illustrating an example of a prompt generated by the determination device in the present disclosure. FIG. 12 illustrates a second prompt P2-1-1 generated by the determination device 10. The second prompt P2-1-1 includes an instruction sentence and vulnerability information associated with a vulnerability identifier. The instruction sentence includes text information that “please determine the necessity of responding to the following vulnerability in accordance with the norm. In a case where information necessary for determination is insufficient, please ask a question”. The vulnerability information includes a plurality of pieces of data in which a key and a value relevant to the vulnerability identifier are associated one-to-one. FIG. 12 illustrates an answer A2-1-1 output from the LLM system 150 in response to the input of the second prompt P2-1-1. The answer A2-1-1 includes text information indicating a question for the worker that “is a server including this vulnerability an external public server?”. The answer A2-1-1 includes text information requesting an input of auxiliary information for determining necessity of responding to the vulnerability.

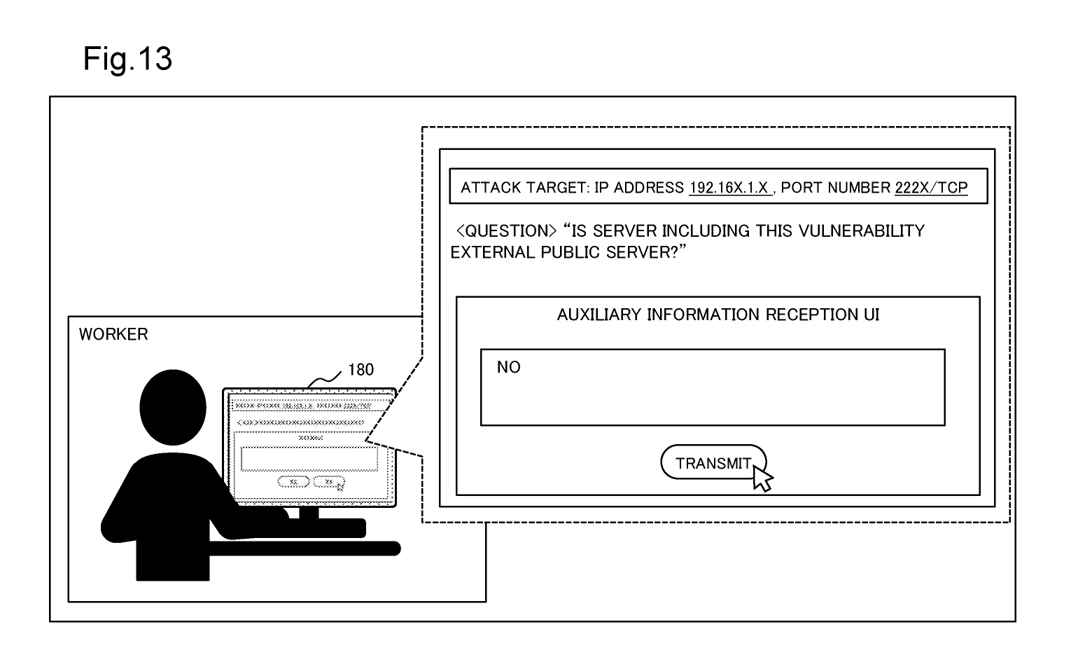

FIG. 13 is a conceptual diagram illustrating an example in which a user interface that receives an input of an answer to a question output from the determination device in the present disclosure is displayed on a screen of the terminal device. On the upper part of the screen of the terminal device 180, an IP address and a port number of an attack target are displayed. On the screen of the terminal device 180, text information of contents requesting the input of auxiliary information that “is the server including this vulnerability an external public server?” is displayed. A user interface (auxiliary information reception UI) for inputting auxiliary information is displayed on the screen of the terminal device 180. A text area for inputting auxiliary information is displayed on the auxiliary information reception UI. In a case where the number of characters of a character string that can be input is small, a text box may be disposed instead of the text area. A button for transmitting the auxiliary information input by the worker to the determination device 10 is displayed on the auxiliary information reception UI. For example, the worker who views information for prompting the input of the auxiliary information displayed on the screen of the terminal device 180 inputs auxiliary information according to a request from the LLM system 150 into the text area. The auxiliary information input into the text area is transmitted to the determination device 10 in response to clicking of a button displayed as “transmit”. In a case where there is no auxiliary information to be input, the worker does not need to input the auxiliary information. In that case, the worker only needs to click the button displayed as “transmit” while leaving the text area blank. In a case where the button displayed as “transmit” is clicked in a state where the auxiliary information is not input into the text area, a configuration in which information indicating that there is no auxiliary information is transmitted to the determination device 10 may be made. In a case where the button displayed as “transmit” is clicked in a state where the auxiliary information is not input into the text area, a configuration in which a pop-up including a message for requesting the input of the auxiliary information is displayed on the screen of the terminal device 180 may be made.

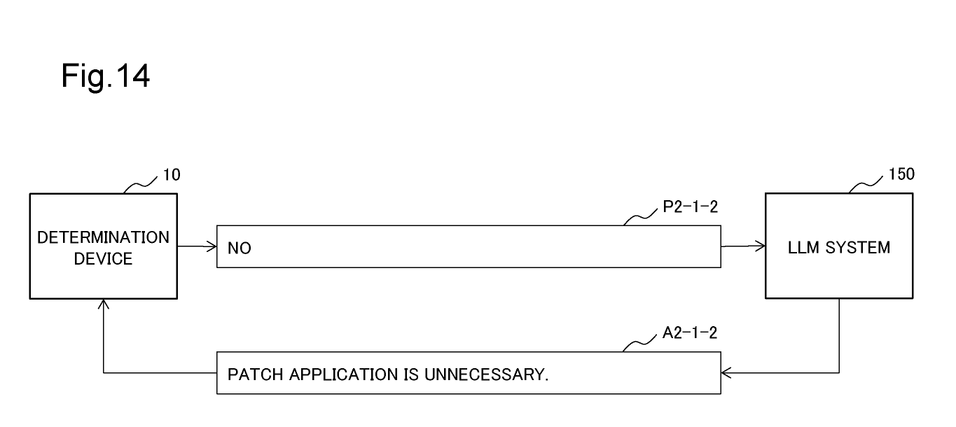

FIG. 14 is a conceptual diagram illustrating another example of the prompt generated by the determination device in the present disclosure. FIG. 14 illustrates a second prompt P2-1-2 generated by the determination device 10. The second prompt P2-1-2 includes an answer input by the worker to the question included in the answer A2-1-1 in FIG. 13. The second prompt P2-1-2 includes text information “No” indicating an answer input by the worker. The information “No” included in the second prompt P2-1-2 is relevant to auxiliary information that “the server including the vulnerability is not the external public server”. FIG. 14 illustrates an answer A2-1-2 output from the LLM system 150 in response to the input of the second prompt P2-1-2. The answer A2-1-2 includes text information that “patch application is unnecessary”. Based on the auxiliary information, the answer A2-1-2 includes a determination result of the necessity of responding to the vulnerability indicated by the vulnerability identifier.

In the present modification, in the determination of the necessity of responding to the vulnerability, the worker is requested to input missing information and information for more appropriate determination. In the present modification, the necessity of responding to the vulnerability is determined by using the auxiliary information input by the worker. According to the present modification, it is possible to present a more precise response to the worker by using the auxiliary information input by the worker.

### Second Modification

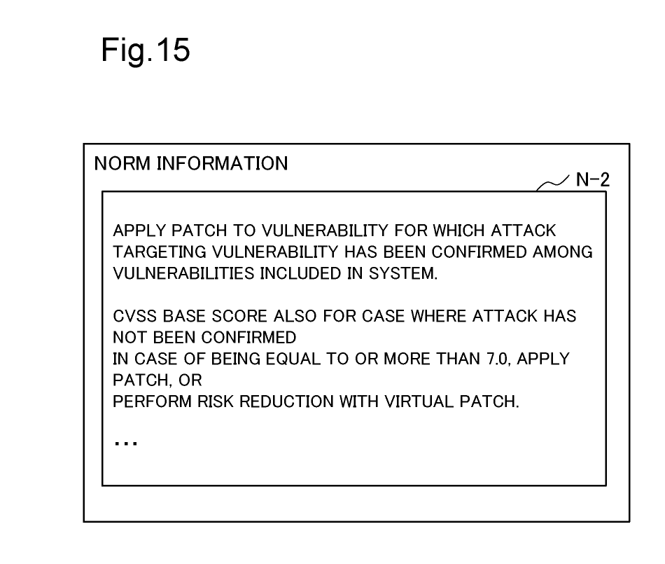

FIGS. 15 to 17 are conceptual diagrams relating to a second modification. The present modification is an example of generating a prompt including an instruction to present a method of responding to a vulnerability identified by a vulnerability identifier. For example, the method of responding to a vulnerability includes Avoid, Mitigate, Transfer, and Accept of risks due to the vulnerability.

FIG. 15 is a conceptual diagram illustrating an example of norm information referred to by a determination device in the present disclosure. In norm information N-2, a response for each risk due to a vulnerability is designated. For example, it is designated to apply a patch to a vulnerability for which an attack targeting the vulnerability has been observed among vulnerabilities included in a system. For example, even in a case where an attack has not been observed, it is designated to perform application of a patch or risk reduction by a virtual patch for a case where a CVSS base score is equal to or more than 7.0.

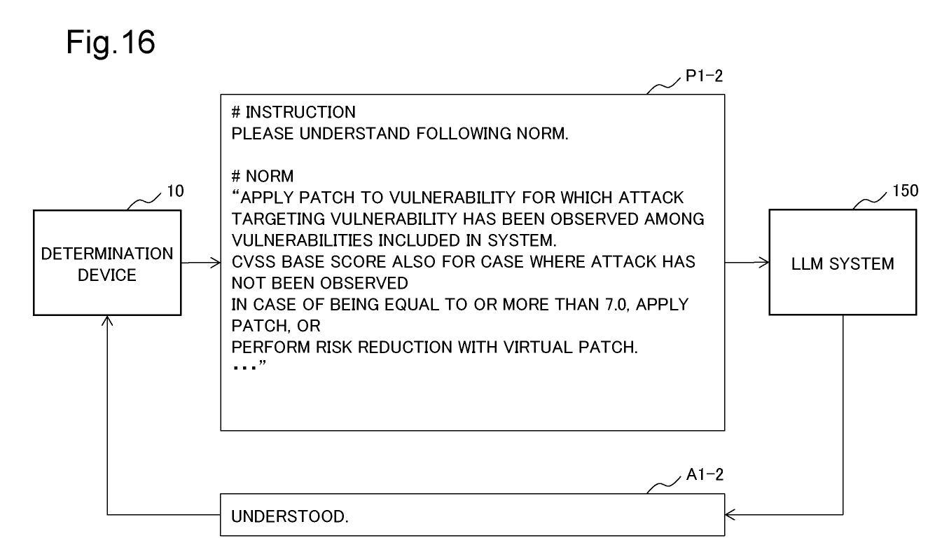

FIG. 16 is a conceptual diagram illustrating an example of a prompt generated by the determination device in the present disclosure. FIG. 16 illustrates an example of a first prompt P1-2 generated by a determination device 10. The first prompt P1-2 includes information indicating an instruction sentence and a norm. The instruction sentence includes text information that “please understand the following norm”. The norm includes a sentence related to the norm illustrated in FIG. 15. FIG. 16 illustrates an answer A1-2 output from the LLM system 150 in response to the input of the first prompt P1-2. The answer A1-2 includes text information indicating that the contents of the first prompt P1-2 are set as a precondition for the LLM system 150, that is, “understood”.

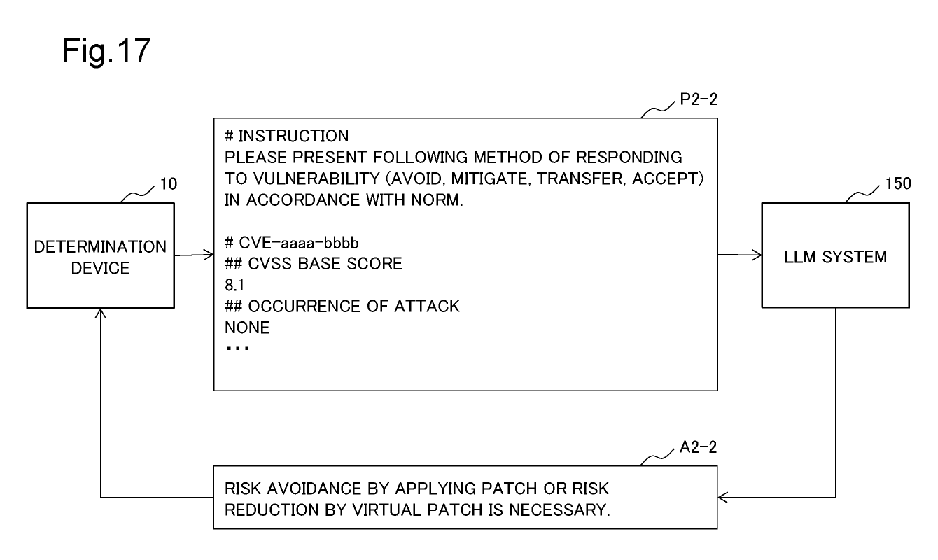

FIG. 17 is a conceptual diagram illustrating an example of a prompt generated by the determination device in the present disclosure. FIG. 17 illustrates a second prompt P2-2 generated by the determination device 10. The second prompt P2-2 includes an instruction sentence and vulnerability information associated with a vulnerability identifier. The instruction sentence includes text information that “please provide the following method of responding to the vulnerability (Avoid, Mitigate, Transfer, Accept) in accordance with the norm”. The vulnerability information includes a plurality of pieces of data in which a key and a value relevant to the vulnerability identifier are associated one-to-one. FIG. 17 illustrates an answer A2-2 output from the LLM system 150 in response to the input of the second prompt P2-2. The answer A2-2 includes a method of responding to the vulnerability that “risk avoidance by applying a patch or risk reduction by a virtual patch is necessary”.

In the present modification, a prompt including an instruction to present a method of responding to a vulnerability identified by a vulnerability identifier is generated. It is necessary for the worker to determine, based on the norm, whether to take any method of responding to the identified vulnerability, such as Avoid, Mitigate, Transfer, and Accept, in addition to simple necessary of responding to the identified vulnerability. According to the present modification, it is possible to present a specific method of responding to a vulnerability to the worker.

### Third Modification

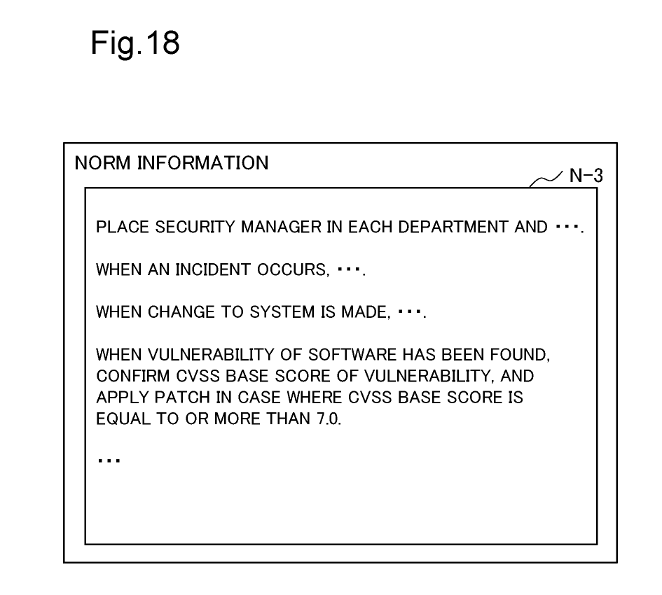

FIGS. 18 to 20 are conceptual diagrams relating to a third modification. The present modification is an example of generating a prompt including an instruction to extract a description regarding a response to a vulnerability from a norm.

FIG. 18 is a conceptual diagram illustrating an example of norm information referred to by a determination device in the present disclosure. Norm information N-3 describes a response to a vulnerability. It is assumed that responses to vulnerabilities, which are described in the norm information N-3, are scattered in text of the norm. Therefore, a normal worker requires many man-hours to extract a response to a vulnerability. For example, it is assumed that, in the norm information N-3, it is designated to apply a patch to a vulnerability for which an attack targeting the vulnerability has been observed among vulnerabilities included in a system. For example, it is assumed that, in the norm information N-3, it is designated to apply a patch for a case where a CVSS base score is equal to or more than 7.0, even in a case where an attack has not been observed.

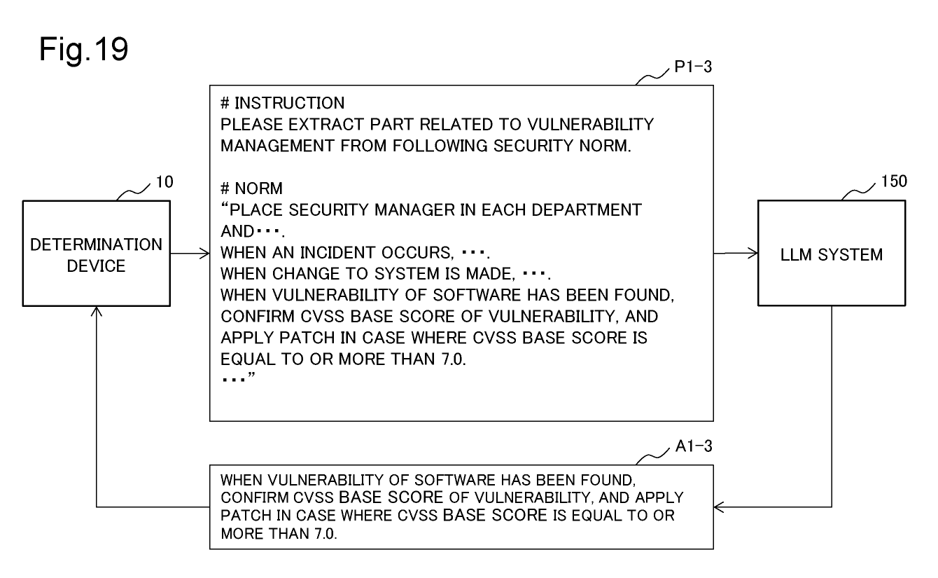

FIG. 19 is a conceptual diagram illustrating an example of a prompt generated by the determination device in the present disclosure. FIG. 19 illustrates an example of a first prompt P1-3 generated by a determination device 10. The first prompt P1-3 includes information indicating an instruction sentence and a norm. The instruction sentence includes text information that “please extract a part related to vulnerability management from the following security norm”. The norm includes a sentence related to the norm illustrated in FIG. 18. FIG. 19 illustrates an answer A1-3 output from the LLM system 150 in response to the input of the first prompt P1-3. The answer A1-3 includes text information indicating a response to the vulnerability extracted from the norm that “when a vulnerability of software has been found, confirm the CVSS base score of the vulnerability, and apply a patch in a case where the CVSS base score is equal to or more than 7.0”.

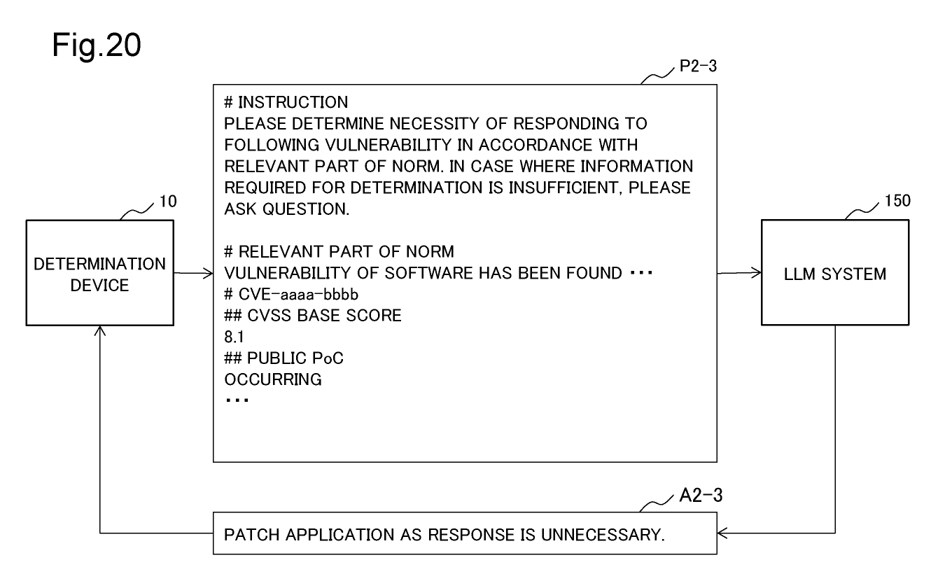

FIG. 20 is a conceptual diagram illustrating an example of a prompt generated by the determination device in the present disclosure. FIG. 20 illustrates a second prompt P2-3 generated by the determination device 10. The second prompt P2-3 includes an instruction, a relevant part of a description regarding vulnerability management in the norm, and vulnerability information associated with a vulnerability identifier. The instruction sentence includes text information that “please determine the necessity of responding to the following vulnerability in accordance with the relevant part of the norm. In a case where information necessary for determination is insufficient, please ask a question”. The relevant part of the description regarding vulnerability management in the norm is indicated by text information that “a vulnerability of software has been found...”. The vulnerability information includes a plurality of pieces of data in which a key and a value relevant to the vulnerability identifier are associated one-to-one. FIG. 20 illustrates an answer A2-3 output from the LLM system 150 in response to the input of the second prompt P2-3. The answer A2-3 includes a determination result for the vulnerability that “patch application as a response is unnecessary”.

In the present modification, the description regarding the vulnerability is extracted from the norm. In the present modification, the necessity of responding to the vulnerability is determined with reference to the extracted description. In the present modification, a sentence related to a vulnerability is extracted from many descriptions including matters other than the vulnerability in the norm. Therefore, according to the present modification, since items other than the vulnerability are not verified in the norm, it is possible to efficiently determine the necessity of responding to the vulnerability.

As described above, the determination device in the present example embodiment includes the acquisition unit, the search unit, the instruction unit, and the output unit. The acquisition unit acquires a vulnerability identifier for uniquely identifying a vulnerability. The search unit refers to a database in which vulnerability information for each vulnerability identifier is registered, and searches for vulnerability information identified by the vulnerability identifier. The instruction unit generates a prompt including an instruction to determine necessity of responding to the vulnerability identified by the vulnerability identifier by using the vulnerability information identified by the vulnerability identifier and the norm regarding information security. The norm is at least one of guidelines, standards, laws, and internal regulations regarding information security. The output unit outputs determination data including a determination result output from a large-scale language model in accordance with the prompt.

In the present example embodiment, the necessity of responding to the vulnerability is determined by using the norm regarding information security. Therefore, according to the present example embodiment, it is possible to present a determination result for supporting decision-making of the worker in vulnerability responding in accordance with the norm regarding information security.

In an aspect of the present example embodiment, the search unit refers to an external database in which vulnerability information for each vulnerability identifier is disclosed, and searches for vulnerability information associated with the vulnerability identifier. According to the present aspect, it is possible to present a determination result for supporting decision-making of the worker by using the disclosed vulnerability information for each vulnerability identifier.

In an aspect of the present example embodiment, the search unit refers to a dedicated database storing vulnerability information for each vulnerability identifier specialized for vulnerability diagnosis of a management target system, and searches for vulnerability information associated with the vulnerability identifier. According to the present aspect, it is possible to present a determination result suitable for operation of the managed system by using vulnerability information for each vulnerability identifier specialized for vulnerability diagnosis of the management target system.

In an aspect of the present example embodiment, the instruction unit receives, from the large-scale language model, a request for auxiliary information for determining necessity of responding to the vulnerability identified by the vulnerability identifier. The output unit outputs a user interface that requests an input of the auxiliary information. The acquisition unit acquires the auxiliary information input via the user interface. The instruction unit inputs a prompt including the acquired auxiliary information to the large-scale language model. According to the present aspect, it is possible to present a more precise response to the worker by using the auxiliary information input by the worker.

In an aspect of the present example embodiment, the instruction unit generates, in accordance with the norm, a prompt including an instruction to present a method of responding to the vulnerability identified by the vulnerability identifier. According to the present aspect, it is possible to present a specific response for avoiding the risk of the vulnerability to the worker.

In an aspect of the present example embodiment, the instruction unit generates a prompt including an instruction to extract, from the norm, a description regarding the vulnerability identified by the vulnerability identifier. According to the present aspect, since items other than the vulnerability are not verified in the norm, it is possible to efficiently determine the necessity of responding to the vulnerability.

### Second Example Embodiment

Next, a determination device according to a second example embodiment will be described with reference to the drawings. The determination device in the present example embodiment is different from the determination device in the first example embodiment in that necessity of responding to a vulnerability is determined based on a vulnerability diagnosis report instead of the vulnerability identifier identified in a management target system. The vulnerability diagnosis report is a list of vulnerabilities included in a specific host or system. The vulnerability diagnosis report includes a vulnerability identifier indicating a vulnerability included in a specific host or system. For example, the vulnerability diagnosis report is a scanning result by a vulnerability scanner. The vulnerability diagnosis report includes a plurality of vulnerability identifiers. Therefore, the determination device in the present example embodiment is different from the first example embodiment also in handling a plurality of vulnerability identifiers.

The determination device in the present example embodiment is connected to a terminal device and an LLM system similar to those in the first example embodiment via a network such as the Internet or an intranet. In the present example embodiment, details of the terminal device and the LLM system will not be described. In the present example embodiment, contents overlapping with those of the first example embodiment will be described in a simplified manner.

### Configuration

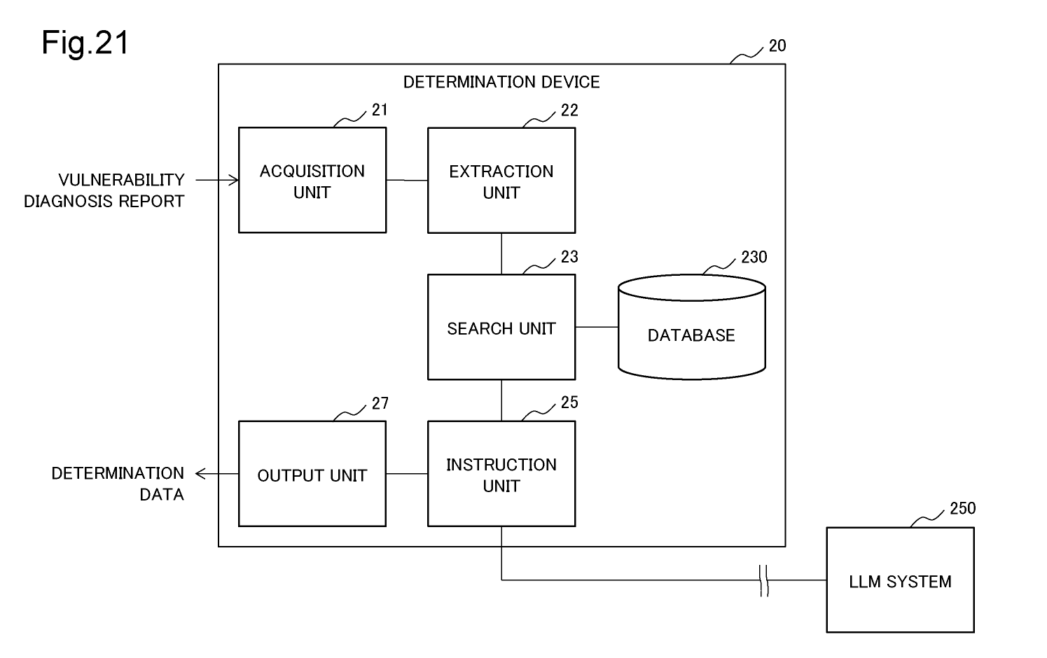

FIG. 21 is a block diagram illustrating an example of a configuration of the determination device in the present disclosure. A determination device 20 includes an acquisition unit 21, a search unit 23, an instruction unit 25, and an output unit 27. The determination device 20 further includes a database 230. The database 230 may be configured outside the determination device 20 as long as the determination device 20 can refer to the database 230. The instruction unit 25 is connected to an LLM system 250.

The acquisition unit 21 acquires a vulnerability diagnosis report including a list of vulnerabilities included in a specific host or system. The vulnerability diagnosis report includes a plurality of vulnerability identifiers. For example, the acquisition unit 21 acquires the vulnerability diagnosis report including a scanning result of the vulnerability scanner. For example, the acquisition unit 21 may be configured to acquire a disclosed vulnerability diagnosis report. The vulnerability diagnosis report includes a vulnerability identifier indicating a vulnerability included in a specific host or system. For example, the vulnerability identifier includes a CVE number, a plug-in ID of the vulnerability scanner, and the like.

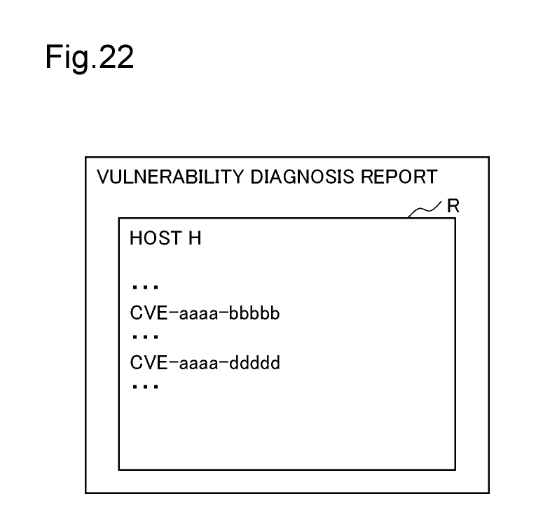

FIG. 22 is a conceptual diagram illustrating an example of the vulnerability diagnosis report acquired by the determination device in the present disclosure. A vulnerability diagnosis report R includes a list of vulnerabilities in a host H. For example, the vulnerability diagnosis report R includes a vulnerability of a vulnerability identifier CVE-aaaa-bbbbb and a vulnerability of a vulnerability identifier CVE-aaaa-ddddd.

An extraction unit 22 extracts the vulnerability identifier included in the vulnerability diagnosis report. For example, the extraction unit 22 extracts a CVE number included in the vulnerability diagnosis report, a plug-in ID of the vulnerability scanner, and the like.

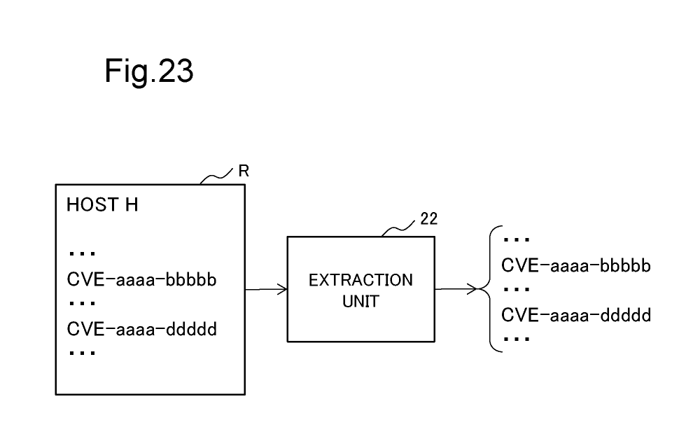

FIG. 23 is a conceptual diagram illustrating an example in which the determination device in the present disclosure extracts a vulnerability identifier from the vulnerability diagnosis report. The extraction unit 22 extracts a vulnerability identifier from a list of vulnerabilities in the host H, which are included in the vulnerability diagnosis report. For example, the extraction unit 22 extracts vulnerability identifiers such as the vulnerability identifier CVE-aaaa-bbbbb and the vulnerability identifier CVE-aaaa-ddddd from the vulnerability diagnosis report R.

The database 230 has the similar configuration to the database 130 in the first example embodiment. The database 230 stores vulnerability information and norm information. The vulnerability information is information associated with the vulnerability identifier. For example, the vulnerability information is information in which information associated with a vulnerability identifier is collected in a table format. The norm information includes information regarding norms such as guidelines, standards, laws, internal regulations, and the like regarding information security. For example, the norm information is a document regarding norms such as guidelines, standards, laws, internal regulations, and the like regarding information security. For example, the norm information may be information extracted from a document regarding norms such as guidelines, standards, laws, internal regulations, and the like regarding information security.

The search unit 23 has the similar configuration to the search unit 13 in the first example embodiment. The search unit 23 searches the database 230 for vulnerability information associated with each vulnerability identifier. For example, the search unit 23 acquires data including a key and a value as the vulnerability information. The search unit 23 searches the database 230 for the norm information referred to in the vulnerability management. For example, the search unit 23 may be configured to search for the vulnerability information and the norm information via the Internet.

The instruction unit 25 acquires vulnerability information and norm information searched for by the search unit 23 for each vulnerability identifier. The instruction unit 25 generates a first prompt for inputting the contents of the norm information to the LLM system 250. The first prompt includes the contents of the norm information. The instruction unit 25 generates a first prompt by using a template set in advance. The template for generating the first prompt includes an instruction sentence to set the contents of the norm information as a precondition. For example, the instruction unit 25 may be configured to generate the first prompt and a second prompt for each vulnerability identifier, and acquire necessity of responding for each vulnerability identifier. Alternatively, the instruction unit 25 may be configured to collectively generate the first prompt and the second prompt for all target vulnerability identifiers and to acquire the necessity of responding for each vulnerability identifier. In this case, each piece of vulnerability information is described for all vulnerability identifiers in the second prompt. The instruction unit 25 inputs the generated first prompt into the LLM system 250.

The instruction unit 25 acquires text information output from the LLM system 250 in response to an input of the first prompt. The text information output from the LLM system 250 in response to the input of the first prompt is relevant to an answer to the first prompt. The answer to the first prompt triggers the determination device 20 to input the second prompt to the LLM system 250.

The instruction unit 25 generates a second prompt for instructing the LLM system 250 to determine necessity of responding to a vulnerability indicated by the vulnerability identifier. The second prompt includes an instruction to determine the necessity of responding to the vulnerability indicated by the vulnerability identifier. The instruction unit 25 generates the second prompt by using a template set in advance. The instruction unit 25 inputs the generated second prompt into the LLM system 250. The instruction unit 25 may be configured to generate a prompt in which the contents of the first prompt and the contents of the second prompt are unified. In that case, the prompt includes an instruction to set the contents of the norm information as a precondition, and an instruction to determine the necessity of responding to the vulnerability indicated by the vulnerability identifier.

The instruction unit 25 acquires text information (determination result) output from the LLM system 250 in response to an input of the second prompt. The text information output from the LLM system 250 in response to the input of the second prompt is relevant to an answer to the second prompt. The answer to the second prompt includes a determination result of the necessity of responding to the vulnerability indicated by the vulnerability identifier.

In the above description, the instruction unit 25 inputs information to the LLM system 250 by using the first prompt and the second prompt and acquires the determination result of the necessity of responding to the vulnerability, and the present example embodiment is not limited to this. For example, the instruction unit 25 may input information to the LLM system 250 by using retrieval-augmented generation (RAG) or fine tuning instead of the first prompt in the above description. For example, the instruction unit 25 may generate a single prompt including both information included in the first prompt and information included in the second prompt. In that case, the instruction unit 25 inputs this single prompt to the LLM system 250, and acquires text information regarding a determination result of necessity of responding to the vulnerability, which has been output from the LLM system 250.

The output unit 27 is connected to a terminal device (not illustrated) used by a worker. The output unit 27 acquires, from the instruction unit 25, a determination result of the necessity of responding to the vulnerability indicated by the vulnerability identifier for each vulnerability identifier. The output unit 27 outputs determination data including the acquired determination result to the terminal device. The determination result included in the determination data output to the terminal device is displayed on a screen of the terminal device.

### Operation

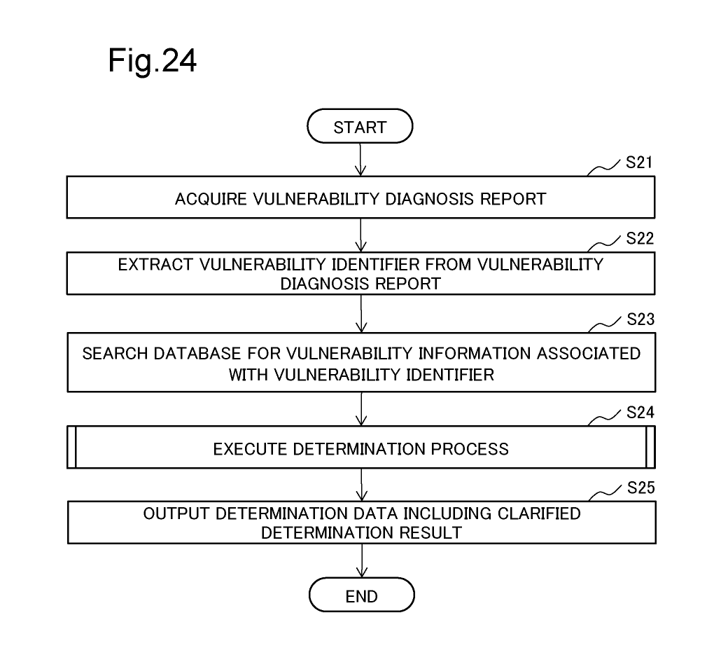

Next, an example of an operation of the determination device in the present disclosure will be described with reference to the drawings. FIG. 24 is a flowchart illustrating the example of the operation of the determination device in the present disclosure. In the description of processing as per the flowchart in FIG. 24, a component of the determination device 20 is assumed as an operating subject. The operating subject of the processing as per the flowchart in FIG. 24 may be the determination device 20. For example, the processing as per the flowchart in FIG. 24 is achieved by a processor executing a program stored in a memory mounted in a computer (not illustrated) in which the determination device 20 is implemented.

In FIG. 24, first, the acquisition unit 21 acquires a vulnerability diagnosis report (Step S21). For example, the acquisition unit 21 acquires the vulnerability diagnosis report including a scanning result of the vulnerability scanner. For example, the acquisition unit 21 may be configured to acquire a disclosed vulnerability diagnosis report.

Then, the extraction unit 22 extracts the vulnerability identifier included in the vulnerability diagnosis report (Step S22). The vulnerability diagnosis report includes a plurality of vulnerability identifiers.

Then, the search unit 23 searches the database 230 for vulnerability information associated with each of the plurality of vulnerability identifiers (Step S23). The search unit 23 may be configured to search for the vulnerability information via the Internet.

Then, the instruction unit 25 executes a determination process (Step S24). The details of the determination process in Step S24 will be described later.

Then, the output unit 27 outputs determination data including the clarified determination result (Step S25). A determination result output from the determination device 20 is displayed on the screen of the terminal device used to perform vulnerability management.

### Determination Process

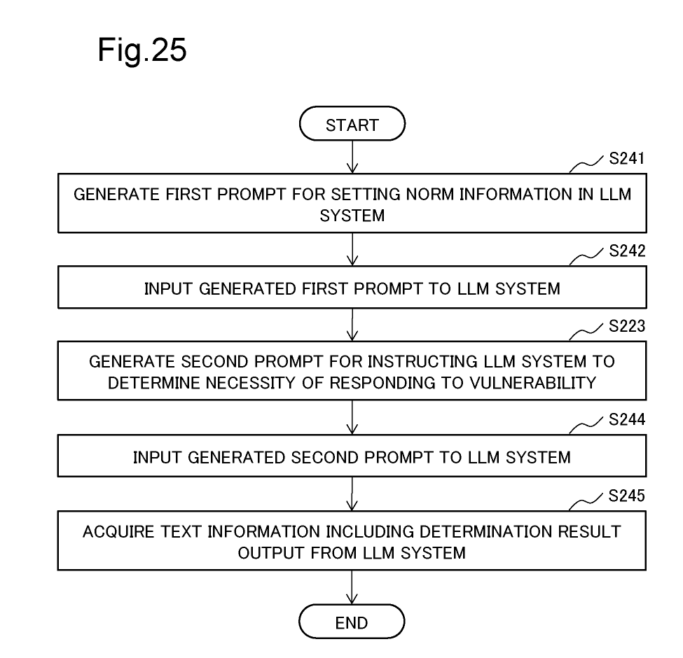

Next, an example of the determination process (Step S24 in FIG. 24) by the determination device in the present disclosure will be described with reference to the drawings. FIG. 25 is a flowchart illustrating an example of the determination process by the determination device in the present disclosure. In the description of the process as per the flowchart in FIG. 25, a component (instruction unit 25) of the determination device 20 is assumed as an operating subject. The operating subject of the process as per the flowchart in FIG. 25 may be the determination device 20.

In FIG. 25, first, the instruction unit 25 generates a first prompt for setting norm information in the LLM system 250 (Step S241).

Then, the instruction unit 25 inputs the generated first prompt into the LLM system 250 (Step S242). The instruction unit 25 acquires text information output from the LLM system 250 in response to an input of the first prompt.

Then, the instruction unit 25 generates a second prompt for instructing the LLM system 250 to determine necessity of responding to a vulnerability (Step S243).

Then, the instruction unit 25 inputs the generated second prompt into the LLM system 250 (Step S244).

Then, the instruction unit 25 acquires text information including the determination result output from the LLM system 250 (Step S245). After Step S245, the process proceeds to Step S25 in the flowchart in FIG. 24.

As described above, the determination device in the present example embodiment includes the acquisition unit, the extraction unit, the search unit, the instruction unit, and the output unit. The acquisition unit acquires a vulnerability diagnosis report including a vulnerability identifier for uniquely identifying a vulnerability. The extraction unit extracts at least one vulnerability identifier from the vulnerability diagnosis report. The search unit refers to a database in which vulnerability information for each vulnerability identifier is registered, and searches for vulnerability information identified by the vulnerability identifier. The instruction unit generates a prompt including an instruction to determine necessity of responding to the vulnerability identified by the vulnerability identifier by using the vulnerability information identified by the vulnerability identifier and the norm regarding information security. The norm is at least one of guidelines, standards, laws, and internal regulations regarding information security. The output unit outputs determination data including a determination result output from a large-scale language model in accordance with the prompt.

In the present example embodiment, the necessity of responding to the vulnerability is determined by using the vulnerability identifier extracted from the vulnerability diagnosis report and the norm regarding information security. Therefore, according to the present example embodiment, even in a case where a specific vulnerability identifier is not identified, it is possible to present a determination result for supporting decision-making of the worker in vulnerability responding based on the vulnerability diagnosis report. According to the present example embodiment, it is possible to present a determination result for supporting decision-making of the worker for the vulnerability indicated by a plurality of vulnerability identifiers included in the vulnerability diagnosis report.

### Third Example Embodiment

Next, a determination device according to a third example embodiment will be described with reference to the drawings. The determination device in the present example embodiment has a configuration in which the determination device in the first and second example embodiments is simplified. For example, functions of components included in the determination device in the present example embodiment are achieved by the functions of the components included in the determination device according to the first and second example embodiments.

### Configuration

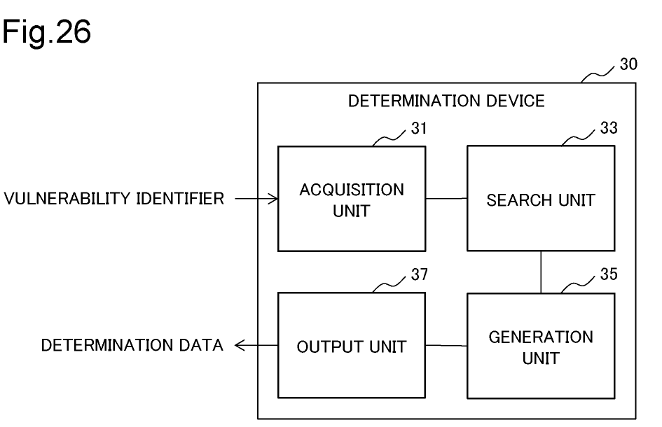

FIG. 26 is a block diagram illustrating an example of a configuration of the determination device in the present disclosure. A determination device 30 includes an acquisition unit 31, a search unit 33, a generation unit 35, and an output unit 37.

The acquisition unit 31 acquires a vulnerability identifier for uniquely identifying a vulnerability. The search unit 33 refers to a database in which vulnerability information for each vulnerability identifier is registered, and searches for vulnerability information identified by the vulnerability identifier. The generation unit 35 generates an instruction to determine necessity of responding to the vulnerability identified by the vulnerability identifier by using the vulnerability information identified by the vulnerability identifier and the norm regarding information security. The output unit 37 outputs determination data including a determination result output from a model in response to the instruction.

### Operation

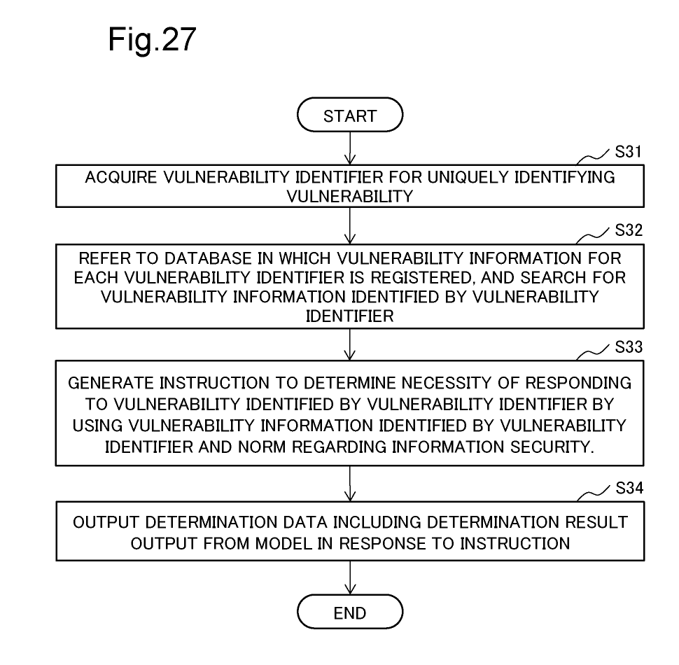

FIG. 27 is a flowchart illustrating an example of an operation of the determination device in the present disclosure. In the description of processing as per the flowchart in FIG. 27, a component of the determination device 30 is assumed as an operating subject. The operating subject of the processing as per the flowchart in FIG. 27 may be the determination device 30.

The acquisition unit 31 acquires a vulnerability identifier for uniquely identifying a vulnerability (Step S31).

The search unit 33 refers to a database in which vulnerability information for each vulnerability identifier is registered, and searches for vulnerability information identified by the vulnerability identifier (Step S32).

The generation unit 35 generates an instruction to determine necessity of responding to the vulnerability identified by the vulnerability identifier by using the vulnerability information identified by the vulnerability identifier and the norm regarding information security (Step S33).

The output unit 37 outputs determination data including a determination result output from a model in response to the instruction (Step S34).

In the present example embodiment, the necessity of responding to the vulnerability is determined by using the norm regarding information security. Therefore, according to the present example embodiment, it is possible to present a determination result for supporting decision-making of the worker in vulnerability responding in accordance with the norm regarding information security.

### Hardware

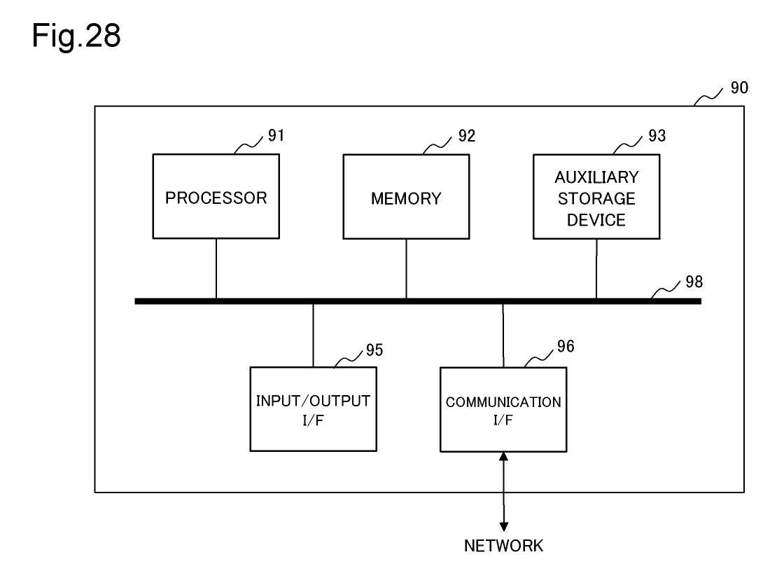

Next, a hardware configuration for executing processing in the present disclosure will be described with reference to the drawings. FIG. 28 is a block diagram illustrating an example of a hardware configuration that executes processing in the present disclosure. Here, an information processing device 90 (computer) is illustrated as an example of the hardware configuration. The information processing device in FIG. 28 is a configuration example for executing processing in the present disclosure, and does not limit the scope of the present disclosure.

As illustrated in FIG. 28, the information processing device 90 includes a processor 91, a memory 92, an auxiliary storage device 93, an input/output interface 95, and a communication interface 96. In FIG. 28, the interface is abbreviated as an I/F. The information processing device 90 may include a plurality of pieces of at least one of the processor 91, the memory 92, the auxiliary storage device 93, the input/output interface 95, and the communication interface 96. The processor 91, the memory 92, the auxiliary storage device 93, the input/output interface 95, and the communication interface 96 are connected to each other via a bus 98 in such a way that data communication is allowed. The processor 91, the memory 92, the auxiliary storage device 93, and the input/output interface 95 are connected to a network such as the Internet or an intranet via the communication interface 96.

The processor 91 loads a program (command) stored in the auxiliary storage device 93 or the like into the memory 92. For example, the program is a software program for executing processing in the present disclosure. The processor 91 executes the program loaded into the memory 92. The processor 91 executes processing in the present disclosure by executing the program. The processor 91 may be constituted by a single piece of hardware or may be constituted by a plurality of pieces of hardware.

The memory 92 is a storage device having an area into which a program is loaded. A program stored in the auxiliary storage device 93 or the like is loaded into the memory 92 by the processor 91. The memory 92 is achieved by, for example, a volatile memory such as a dynamic random access memory (DRAM). A nonvolatile memory such as a magnetoresistive random access memory (MRAM) may be applied as the memory 92. The memory 92 may be constituted by a single piece of hardware or may be constituted by a plurality of pieces of hardware.

The auxiliary storage device 93 stores various types of data such as programs. For example, the auxiliary storage device 93 is achieved by a local disk such as a hard disk or a flash memory. The auxiliary storage device 93 may be constituted by a single piece of hardware or may be constituted by a plurality of pieces of hardware. The auxiliary storage device 93 may be configured as external hardware. The memory 92 may be formed to store various types of data in such a way that the auxiliary storage device 93 can be omitted.

The input/output interface 95 is an interface for connecting the information processing device 90 and peripheral equipment in accordance with a standard or a specification. The communication interface 96 is an interface for connecting to an external system or device through a network such as the Internet or an intranet in accordance with a standard or a specification. The input/output interface 95 may be constituted by a single piece of hardware or may be constituted by a plurality of pieces of hardware. The input/output interface 95 and the communication interface 96 may be merged as an interface connected to external equipment.

Input equipment such as a keyboard, a mouse, and a touch panel may be connected to the information processing device 90, as necessary. These sorts of input equipment are used to input information and settings. In a case where the touch panel is used as the input equipment, a screen having a touch panel function serves as an interface. The processor 91 and the input equipment are connected via the input/output interface 95.

The information processing device 90 may be provided with display equipment for displaying information. In a case where the display equipment is provided, the information processing device 90 includes a display control device (not illustrated) for controlling display on the display equipment. The information processing device 90 and the display equipment are connected via the input/output interface 95.

The information processing device 90 may be provided with a drive device. The drive device mediates reading of data and a program stored in a recording medium and writing of a processing result of the information processing device 90 to the recording medium between the processor 91 and the recording medium (program recording medium). The information processing device 90 and the drive device are connected via the input/output interface 95.

The above is an example of the hardware configuration for enabling processing in the present disclosure. The hardware configuration in FIG. 28 is an example of the hardware configuration for executing processing in the present disclosure and does not limit the scope of the present disclosure. A program for causing a computer to execute processing in the present disclosure is also included in the scope of the present disclosure.

A program recording medium in which a program for executing processing in the present example embodiment is recorded is also included in the scope of the present invention. For example, the program recording medium is a non-transitory computer-readable recording medium. The recording medium can be achieved by, for example, an optical recording medium such as a compact disc (CD) or a digital versatile disc (DVD). The recording medium may be achieved by a semiconductor recording medium such as a universal serial bus (USB) memory or a secure digital (SD) card. The recording medium may be achieved by a magnetic recording medium such as a flexible disk, or other recording media.

The components in the present disclosure may be combined in any manner. The components in the present disclosure may be achieved by software. The components in the present disclosure may be achieved by a circuit. The components in the present disclosure may be achieved by cloud computing.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other example embodiments.

Some or all of the above example embodiments may be described as the following Supplementary Notes, but are not limited to the following Supplementary Notes. In the following Supplementary Notes, dependent items in each category may also depend on other categories. The description included in the following Supplementary Notes has significance as a basis for amendment.

### Supplementary Note 1

A determination device including:

an acquisition unit that acquires a vulnerability identifier for uniquely identifying a vulnerability;

a search unit that refers to a database in which vulnerability information for each vulnerability identifier is registered and searches for vulnerability information identified by the vulnerability identifier;

a generation unit that generates an instruction to determine necessity of responding to a vulnerability identified by the vulnerability identifier by using the vulnerability information identified by the vulnerability identifier and a norm regarding information security; and

an output unit that outputs determination data including a determination result output from a model in response to the instruction.

### Supplementary Note 2

The determination device according to Supplementary Note 1, in which the norm is at least one of a guideline, a standard, a law, or an internal regulation regarding the information security.

### Supplementary Note 3

The determination device according to Supplementary Note 2, in which

the search unit refers to an external database in which vulnerability information for each vulnerability identifier is disclosed, and searches for vulnerability information associated with the vulnerability identifier.

### Supplementary Note 4

The determination device according to Supplementary Note 2, in which

the search unit refers to a dedicated database storing vulnerability information for each vulnerability identifier specialized for vulnerability diagnosis of a management target system, and searches for vulnerability information associated with the vulnerability identifier.

### Supplementary Note 5

The determination device according to Supplementary Note 1, further including:

an extraction unit that extracts a vulnerability identifier from a vulnerability diagnosis report, in which

the acquisition unit

the extraction unit

acquires the vulnerability diagnosis report, and

extracts at least one vulnerability identifier from the acquired vulnerability diagnosis report.

### Supplementary Note 6

The determination device according to any one of Supplementary Notes 1 to 5, in which

the generation unit

receives, from the model, a request for auxiliary information for determining necessity of responding to a vulnerability identified by the vulnerability identifier,

the output unit

outputs a user interface that requests an input of auxiliary information,

the acquisition unit

acquires auxiliary information input via the user interface, and

the generation unit

generates a prompt including the acquired auxiliary information.

### Supplementary Note 7

The determination device according to any one of Supplementary Notes 1 to 5, in which

the generation unit generates an instruction to present a method of responding to a vulnerability identified by the vulnerability identifier in accordance with the norm.

### Supplementary Note 8

The determination device according to any one of Supplementary Notes 1 to 5, in which

the generation unit generates an instruction to extract, from the norm, a description regarding a vulnerability identified by the vulnerability identifier.

### Supplementary Note 9

A determination method including:

by a computer,

acquiring a vulnerability identifier for uniquely identifying a vulnerability;

referring to a database in which vulnerability information for each vulnerability identifier is registered and searching for vulnerability information associated with the vulnerability identifier;

generating an instruction to determine necessity of responding to a vulnerability identified by the vulnerability identifier by using the vulnerability information identified by the vulnerability identifier and a norm regarding information security; and

outputting determination data including a determination result output from a model in response to the instruction.

### Supplementary Note 10

A program for causing a computer to execute a process including:

acquiring a vulnerability identifier for uniquely identifying a vulnerability;

referring to a database in which vulnerability information for each vulnerability identifier is registered and searching for vulnerability information associated with the vulnerability identifier;

generating an instruction to determine necessity of responding to a vulnerability identified by the vulnerability identifier by using the vulnerability information identified by the vulnerability identifier and a norm regarding information security; and

outputting determination data including a determination result output from a model in response to the instruction.

Some or all of the configurations described in Supplementary Notes 2 to 8 dependent on the above-described Supplementary Note 1 can also be dependent on Supplementary Notes 9 and 10 by the same dependency relationship as in Supplementary Notes 2 to 8. Some or all of the configurations described as the Supplementary Notes can be similarly dependent on not only the Supplementary Notes 1, 9, and 10, but also diverse pieces of hardware and software, various recording means for recording software, or systems without departing from the above-described example embodiments.

1. A determination device comprising:
a memory storing instructions; and
a processor connected to the memory and configured to execute the instructions to:
acquire a vulnerability identifier for uniquely identifying a vulnerability;
search for vulnerability information identified by the vulnerability identifier by referring to a database in which vulnerability information for each vulnerability identifier is registered;
generate an instruction to determine necessity of responding to a vulnerability identified by the vulnerability identifier by using the vulnerability information identified by the vulnerability identifier and a norm regarding information security; and
output determination data including a determination result output from a model in response to the instruction.

2. The determination device according to claim 1, wherein
the norm is at least one of a guideline, a standard, a law, or an internal regulation regarding the information security.

3. The determination device according to claim 2, wherein
the processor is configured to execute the instructions to
search for vulnerability information associated with the vulnerability identifier by referring to an external database in which vulnerability information for each vulnerability identifier is disclosed.

4. The determination device according to claim 2, wherein
the processor is configured to execute the instructions to
search for vulnerability information associated with the vulnerability identifier by referring to a dedicated database storing vulnerability information for each vulnerability identifier specialized for vulnerability diagnosis of a management target system.

5. The determination device according to claim 1, wherein
the processor is configured to execute the instructions to:
acquire a vulnerability diagnosis report; and
extract at least one vulnerability identifier from the acquired vulnerability diagnosis report.

6. The determination device according to claim 1, wherein
the processor is configured to execute the instructions to:
receive, from the model, a request for auxiliary information for determining necessity of responding to a vulnerability identified by the vulnerability identifier;
output a user interface that requests an input of auxiliary information;
acquire auxiliary information input via the user interface; and
generate a prompt including the acquired auxiliary information.

7. The determination device according to claim 1, wherein
the processor is configured to execute the instructions to
generate an instruction to present a method of responding to a vulnerability identified by the vulnerability identifier in accordance with the norm.

8. The determination device according to claim 1, wherein
the processor is configured to execute the instructions to
generate an instruction to extract, from the norm, a description regarding a vulnerability identified by the vulnerability identifier.

9. A determination method comprising:
by a computer,
acquiring a vulnerability identifier for uniquely identifying a vulnerability;
searching for vulnerability information identified by the vulnerability identifier by referring to a database in which vulnerability information for each vulnerability identifier is registered;
generating an instruction to determine necessity of responding to a vulnerability identified by the vulnerability identifier by using the vulnerability information identified by the vulnerability identifier and a norm regarding information security; and
outputting determination data including a determination result output from a model in response to the instruction.

10. A recording medium storing a program for causing a computer to execute a process comprising:
acquiring a vulnerability identifier for uniquely identifying a vulnerability;
searching for vulnerability information identified by the vulnerability identifier by referring to a database in which vulnerability information for each vulnerability identifier is registered;
generating an instruction to determine necessity of responding to a vulnerability identified by the vulnerability identifier by using the vulnerability information identified by the vulnerability identifier and a norm regarding information security; and
outputting determination data including a determination result output from a model in response to the instruction.
